(19) United States
(12) Patent Application Publication
(10) Pub. No.: US 2017/0269594 A1
(43) Pub. Date: Sep. 21, 2017

(54) Controlling an Unmanned Aerial System

(71) Applicant: Bryan Sydnor, Long Beach, CA (US)

(72) Inventor: Bryan Sydnor, Long Beach, CA (US)

(21) Appl. No.: 15/456,952

(22) Filed: Mar. 13, 2017

Related U.S. Application Data
(60) Provisional application No. 62/309,018, filed on Mar. 16, 2016.

(51) Int. Cl. G05D 1/00; B64C 39/02; G05D 1/10

(52) U.S. Cl. CPC G05D 1/0077; G05D 1/0011; G05D 1/101; B64C 39/024; B64C 2201/146

(57) ABSTRACT

In an improved unmanned aerial vehicle control system and method, an unmanned aerial vehicle remotely accepts a flight control command and a collision avoidance command. The unmanned aerial vehicle implements the flight control command in an absence of the collision avoidance command. The unmanned aerial vehicle travels along a path in accordance with the flight control command. The unmanned aerial vehicle stops traveling along the path in response to the collision avoidance command. A primary controller remotely provides the flight control command to the unmanned aerial vehicle in response to manipulation of a flight control device by a remote pilot. An alternate controller remotely provides the collision avoidance command to the unmanned aerial vehicle in response to activation of an alternate mode activator by a remote observer.

### CROSS-REFERENCE TO RELATED APPLICATIONS

This patent application claims the benefit of U.S. Provisional Patent No. 62/309,018 filed Mar. 16, 2016. The content of U.S. Provisional Patent No. 62/309,018 is incorporated herein by reference.

### BACKGROUND

Videographers, cinematographers, scientists, hobbyists, farmers, and the military have long recognized the value in being able to offset a sensor platform (e.g., for video or film cameras) from direct hand control. For example, boom arms, helicopters, airplanes, body attachments, and balloons have long been used to mount a camera in order to gain additional perspectives or points of view not easily obtainable by a camera operator holding the camera. Advances in battery energy density and stability control systems have recently enabled unmanned aerial/aircraft systems (UASs), unmanned aerial vehicles (UAVs) or drones to be smaller, less costly, and more powerful, so that these devices have also become viable sensor or camera platforms for use by videographers, filmmakers, scientists, hobbyists, and dismounted warfighters. The military, in particular, has developed UASs as intelligence, surveillance and reconnaissance platforms.

In traditional (manual) control systems, the ability to operate a UAS in a smooth, steady and stable manner was part of the skillset of an operator, user, or pilot. This arrangement limited control to within the depth perception range and human reaction time of the operator when using visual cues to maintain vehicle stability. The advent of onboard motion control systems having internal or automatic stability mechanisms removed some of the vehicle stability control burden from the operator thereby making vehicle control easier. However, as with displaced traditional control systems, onboard motion control systems still rely on the depth perception, attentiveness and reactions of the operator/pilot to safely maintain separation of the UAS from obstacles or other moving objects, while planning and executing control commands enabling movement of the UAS along a desired trajectory or path.

Automatic collision detection and avoidance technology, or sense-and-avoid systems, have the potential to relieve some of the vehicle safety burden from the operator. Such a system (airborne, ground-based or a combination of the two) could autonomously alert a UAS that it is about to collide into another aircraft, a building, a bridge, a billboard, a bird, etc. However, such technology is still years away from complete implementation. Thus, the FAA (Federal Aviation Administration) has not approved the use of fully automated safety technology for UASs. In fact, rules proposed by the FAA in 2015 for small UASs stipulated that a UAS would be allowed to fly only during the daytime and only within a remote pilot's line of sight, so that the remote pilot would always be able to avoid collisions by manually operating the UAS. Additionally, the liability insurance industry also has not accepted the use of fully automated safety technology for UASs. It is, thus, the pilot's responsibility to stop a potentially unsafe action.

The pilot, however, can become distracted by the requirement to operate the UAS for a particular objective. For example, the pilot may be controlling the UAS to follow a ground based vehicle, so that an onboard camera can film a sequence for a motion picture. In this example, the pilot is primarily concerned with following the ground based vehicle and responding to the needs of the camera operator, rather than keeping watch for potential collisions. In some cases, therefore, the pilot has another person serve as a safety observer to help keep watch and to alert the pilot of approaching unsafe conditions. However, in some flight situations the combined reaction time of both the pilot and the safety observer is too long to provide adequate vehicle safety.

### SUMMARY

In some embodiments, an improved unmanned aerial vehicle control system includes an unmanned aerial vehicle, a primary controller, and an alternate controller. The unmanned aerial vehicle has a control processing circuitry and a motion response subsystem in operative communication. The unmanned aerial vehicle is configured to remotely accept a flight control command and a collision avoidance command. The control processing circuitry is configured to receive the flight control command and to produce a motion control signal that implements the flight control command in an absence of the collision avoidance command. The motion response subsystem is configured to cause the unmanned aerial vehicle to travel along a path in response to the motion control signal in accordance with the flight control command. The control processing circuitry is configured to receive the collision avoidance command and to stop the unmanned aerial vehicle from traveling along the path in response to the collision avoidance command. The primary controller has a flight control device and is configured to remotely provide the flight control command to the unmanned aerial vehicle in response to manipulation of the flight control device by a remote pilot. The alternate controller, separate from the primary controller, has an alternate mode activator and is configured to remotely provide the collision avoidance command to the unmanned aerial vehicle in response to activation of the alternate mode activator by a remote observer.

In some embodiments, an improved method includes transmitting, by a primary controller to an unmanned aerial vehicle in response to manipulation of a flight control device by a remote pilot, a flight control command that indicates a flight path for the unmanned aerial vehicle. The unmanned aerial vehicle receives the flight control command. The unmanned aerial vehicle operates a propulsion device to cause the unmanned aerial vehicle to travel along the flight path in response to the flight control command in an absence of a collision avoidance command. An alternate controller transmits the collision avoidance command to the unmanned aerial vehicle in response to activation of an alternate mode activator by a remote observer. The unmanned aerial vehicle receives the collision avoidance command. The unmanned aerial vehicle operates the propulsion device to cause the unmanned aerial vehicle to stop travelling along the flight path in response to the collision avoidance command.

In some embodiments, lateral momentum of the unmanned aerial vehicle is brought to a stop in response to the collision avoidance command. In some embodiments, the unmanned aerial vehicle is caused to hover in place in response to the collision avoidance command. In some embodiments, the unmanned aerial vehicle changes altitude prior to hovering in place in response to the collision avoidance command. In some embodiments, the unmanned aerial vehicle gains or loses altitude prior to hovering in place in response to a second or third type of collision avoidance command. In some embodiments, the unmanned aerial vehicle changes a direction of travel in response to the collision avoidance command. In some embodiments, the collision avoidance command includes a velocity vector of another aerial vehicle; and the unmanned aerial vehicle changes the direction of travel based on the velocity vector of the other aerial vehicle.

In some embodiments, an external object tracker generates external object data indicative of movement of an external object and transmits the external object data to the unmanned aerial vehicle. The unmanned aerial vehicle travels along the flight path based on the external object data in addition to the flight control command. In some embodiments, the flight path of the unmanned aerial vehicle is offset (based on the flight control command) from a path of the external object tracker.

### BRIEF DESCRIPTION OF THE DRAWINGS

FIG. 1 is top view of an example simplified situation in which a UAS is operated in accordance with one or more example embodiments.

FIG. 2 is a top view of another simplified example situation in which a UAS is operated in accordance with one or more example embodiments.

FIG. 3 is a simplified schematic of a UAS control system for use in the simplified example situations shown in FIGS. 1 and 2, in accordance with one or more example embodiments.

FIG. 4 is a simplified schematic of a UAS for use in the UAS control system shown in FIG. 3, in accordance with one or more example embodiments.

FIG. 5 is a simplified flow diagram for operation of an example external object tracker for use in the UAS control system shown in FIG. 3, in accordance with one or more example embodiments.

FIG. 6 is a simplified flow diagram for operation of an example primary controller for use in the UAS control system shown in FIG. 3, in accordance with one or more example embodiments.

FIG. 7 is a simplified flow diagram for operation of an example alternate controller for use in the UAS control system shown in FIG. 3, in accordance with one or more example embodiments.

FIGS. 8-11 are simplified flow diagrams for operation of components of the UAS shown in FIG. 4, in accordance with example embodiments.

FIG. 12 is a simplified flow diagram for operation of another example external object tracker for use in the UAS control system shown in FIG. 3, in accordance with one or more example embodiments.

FIG. 13 is a simplified flow diagram for operation of another example primary controller for use in the UAS control system shown in FIG. 3, in accordance with one or more example embodiments.

FIG. 14 is a simplified flow diagram for operation of another example alternate controller for use in the UAS control system shown in FIG. 3, in accordance with one or more example embodiments.

FIGS. 15-17 are simplified flow diagrams for alternative operation of the UAS shown in FIG. 4, in accordance with example embodiments.

FIG. 18 is a simplified flowchart for a process for operation of the UAS shown in FIG. 4, in accordance with one or more example embodiments.

FIG. 19 is a simplified flowchart for another process for operation of the UAS shown in FIG. 4, in accordance with one or more example embodiments.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

The subject matter described herein provides new and improved motion control system techniques for control of an unmanned system. In particular, a coordinated control system is provided that can enable various external sources to provide input when controlling the unmanned system.

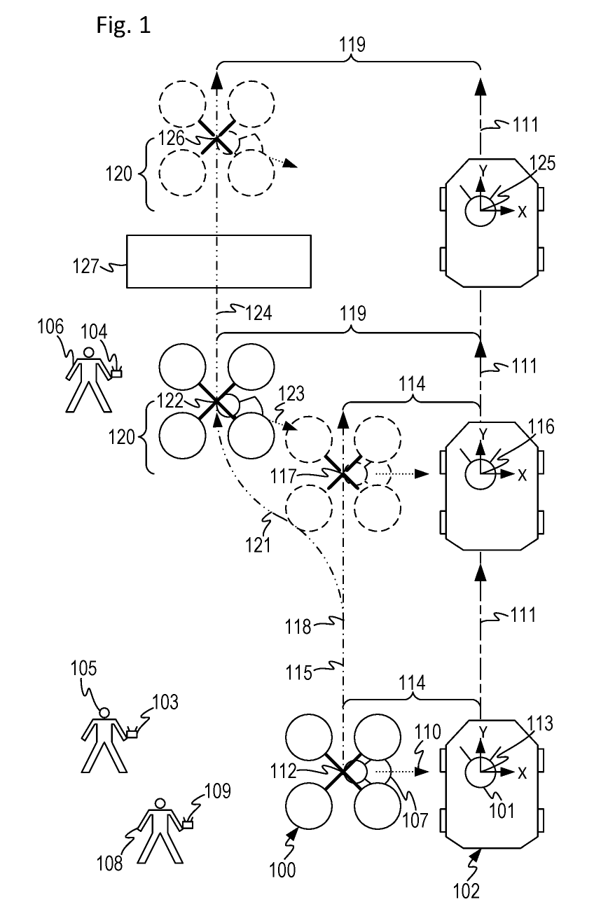

FIG. 1 shows an example situation in which a UAS 100 (e.g., a UAV, a multi-rotor, a drone, a quadcopter or “quad,” an unmanned airplane, a “small unmanned air system” as defined by the FAA, etc.) is operated relative to an external object tracker 101 in accordance with some embodiments. Some of the embodiments described herein can be modified for use with a ground based unmanned system, such as a remotely operated vehicle (ROV), remote-controlled car, boat, submarine, etc. Also, in some embodiments, the “unmanned system” is capable of carrying, for example, passengers, cargo, payload, etc.

The external object tracker 101 in this example is mounted in or on an external object 102, such as a vehicle, car, automobile, truck, boat, aircraft, train, person, animal, etc. The external object tracker 101 is configured to remotely provide data for its location, vector and/or orientation to the UAS 100. A primary controller 103 is configured to remotely provide data for flight control commands to the UAS 100, e.g., to alter the position of the UAS 100 relative to the external object tracker 101. The UAS 100 is configured to receive or remotely accept the data from the external object tracker 101 and the primary controller 103 and to determine a desired flight path based on this data in order to follow the external object tracker 101, and thus the external object 102, as the external object tracker 101 moves with the external object 102. An alternate controller 104 is configured to remotely provide data or commands to the UAS 100 for avoiding collisions or dangerous flight conditions or to augment the actions of the primary controller 103. The UAS 100 is further configured to receive the data or commands from the alternate controller 104 and to stop travelling on its desired flight path in response to this data.

In some embodiments, the UAS or UAV coordinated control system (including the UAS 100, the external object tracker 101, the primary controller 103, and one or more of the alternate controller 104) enables various external sources to provide input when controlling the UAS 100. The UAS coordinated control system utilizes an internal motion control system (described below) of the UAS 100 to maintain stability, and the alternate controller 104 to provide input that changes the motion of the UAS 100. Additionally, the UAS control system enables manual vehicle safety features greater than that described above and that do not rely on automatic collision detection and avoidance technology.

In some embodiments, the UAS control system allows control of the UAS 100 by a remote pilot (i.e., the “pilot in command” or “PIC” for the UAS 100, or the individual in control of an aircraft and ultimately responsible for its operation and safety during flight) 105 as if the remote PIC 105 were present on the external object 102 that the UAS 100 is following, even if the remote PIC 105 is not actually moving with the external object 102. In some embodiments, as the UAS 100 undergoes normal flight operations under control of the primary controller 103 operated by the remote PIC 105, a safety or visual observer (VO) 106 is ready with the alternate controller 104 to immediately override the normal flight operations or take over control of the UAS 100. The alternate controller 104 does this override by transmitting a command (e.g., a collision avoidance command) upon activation by the safety observer 106 when the safety observer 106 perceives that the UAS 100 is approaching an unsafe condition (e.g., a potential collision with a moving or stationary object) or appears to be malfunctioning. Thus, the safety observer 106 immediately steps in with the alternate controller 104 to prevent the collision, instead of simply alerting the remote PIC 105 of the imminent problem. In this manner, any potential delay (e.g., due to the depth perception, attentiveness and reaction time of both the remote PIC 105 and the safety observer 106) in preventing the collision is minimized, and the safety of the UAS 100 and surrounding objects is maximized.

In some embodiments, the UAS 100 has a camera 107 mounted thereon for filming the external object 102 for a film, video, motion picture, or TV program (herein together the “motion picture”). Alternatively, the camera 107 can be used for inspecting power lines, natural disaster damage (e.g., where ground transportation has been interrupted or is non-existent), farmland (e.g., to gauge the health of crops, the need for fertilizer or water, etc.), ranchland (e.g., to assess grazing lands or movement/grazing of herds of livestock), etc.; for performing a geographical information system survey; or for carrying out disaster relief programs; particularly when the work involves following or shadowing an external object or obtaining video of remote areas.

While the UAS 100 is operated by the remote PIC 105 with the primary controller 103, the camera 107 is operated by a camera operator 108 with a remote camera controller 109 to keep the camera 107 pointed at the external object 102, as indicated by arrow 110. In this example, therefore, the remote PIC 105 is primarily concerned with making sure that the UAS 100 properly follows the external object 102 during a normal flight mode in a manner that allows the camera operator 108 to film the external object 102 and any relevant surrounding objects, vehicles, actors, etc. (The “normal flight mode” is generally a flight mode in which the remote PIC 105 controls the UAS 100 to accomplish a desired objective, mission or task.) In doing so, the remote PIC 105 listens for instructions from various people, such as the camera operator 108 and/or a cinematographer/director/etc. for the motion picture, for adjusting the position or flight path of the UAS 100 relative to the external object 102. Thus, the attention of the remote PIC 105 is generally directed away from other surrounding objects, such as roadside billboards, bridge overpasses, power/telephone lines/poles, buildings, balloons, other manned/unmanned aircraft, a person/actor on a stage or set, a theater set piece, another UAS, etc. In other words, the remote PIC 105 is not always keeping watch for potential collisions between the UAS 100 and such other surrounding objects.

The safety observer 106, on the other hand, is tasked with the general responsibility of keeping watch for potential collisions or dangerous flight conditions. In some embodiments, therefore, while the UAS 100 proceeds in the normal flight mode, the safety observer 106 watches and remains ready to trigger an alternate mode activator (e.g., a button, toggle switch, joystick, etc., as described below) on the alternate controller 104 in order to be able to immediately interrupt or override the normal flight mode in order to rapidly bring the UAS 100 to a stop or to take control of the UAS 100 when the safety observer 106 perceives an approaching unsafe condition. In some embodiments, the role or (some or all of) the functions of the safety observer 106 can alternatively or optionally be performed by additional “safety personnel,” such as one or more alternate/additional safety observers 106, the remote PIC 105 of the UAS 100, the remote PIC of another UAS within the same vicinity as the UAS 100, and/or a PIC, co-pilot or other flight personnel of a manned aircraft within the same vicinity as the UAS 100. In some embodiments, therefore, the safety observer 106 represents any number of each of these types of persons. With a plurality of such safety observers 106, any one of them can interrupt the flight of the UAS 100. Additionally, priority may be given to the most recent safety observer 106 to take control of the UAS 100. Alternatively, priority may be given to the most critical safety observer 106 to take control of the UAS 100, e.g., a PIC of a manned aircraft may be considered more critical than other safety observers, since the safety of the manned aircraft would be of primary concern.

In the illustrated example, the UAS 100 executes a change in operation relative to the external object tracker 101, which moves in a straight line or track, as indicated by arrow 111. Initially, when the UAS 100 and the external object tracker 101 are at positions 112 and 113, respectively, the UAS 100 is directed to fly relative to the external object tracker 101 with a first X-direction offset 114 (in a negative X direction), zero Y-direction offset, and any appropriate Z-direction (altitude, not shown) offset from the external object tracker 101. A rectilinear X-Y coordinate system is shown centered on the external object tracker 101, with the Z-direction perpendicular to the plane of FIG. 1.

As the external object tracker 101 travels in a straight line along the arrow 111, the UAS 100 travels in a straight line or track, as indicated by arrow 115, such that the UAS 100 maintains the first X-direction offset 114 (with zero Y-direction and any appropriate constant Z-direction offsets) relative to the external object tracker 101. If the UAS 100 were to maintain this flight offset, then when the external object tracker 101 reached position 116, the UAS 100 would be at position 117. However, in the illustrated example, when the UAS 100 is at about position 118, the remote PIC 105 manipulates one or more flight control devices (described below) of the primary controller 103, which causes the primary controller 103 to remotely transmit one or more flight control commands to the UAS 100, e.g., to move a specified distance relative to its initial location while following the external object tracker 101. The flight control commands thus instruct the UAS 100 to change both the X and the Y coordinates of the UAS 100 relative to the external object tracker 101.

The UAS 100 translates the flight control commands to interpret where the UAS 100 should be relative to the external object tracker 101. The UAS 100 then performs the necessary changes to its motion to achieve the desired location relative to the external object tracker 101. In other words, the flight control commands cause the UAS 100 to change (e.g., by flying along the track indicated by arrow 121) from a first state or position relative to the external object tracker 101 (where the UAS 100 was relatively close to and in line with the external object tracker 101) to a second state or position relative to the external object tracker 101 (where the UAS 100 is further away at a second X-direction offset 119 and slightly ahead at a first Y-direction offset 120 from the external object tracker 101). Thus, when the external object tracker 101 reaches position 116, the UAS 100 will be at position 122. Additionally, the camera operator 108 uses the remote camera controller 109 to adjust the camera 107 to point along arrow 123 toward the external object 102 to continue filming.

If the UAS 100 were to maintain the new flight path or track without obstruction along arrow 124, then when the external object tracker 101 reached position 125, the UAS 100 would be at position 126. However, in the illustrated example, the safety observer 106 perceives that an object 127 is in the path of the UAS 100. (In some embodiments, one or more of the safety observer 106 with one or more of the alternate controller 104 are positioned near one or more object that are known to be close to the desired path that the UAS 100 is going to travel, so that the safety observers 106 can more easily perceive potential dangers than can the remote PIC 105. Additional safety observers 106 with additional alternate controllers 104 can also be placed near locations of the desired path that are outside of the line of sight of the remote PIC 105.) The safety observer 106 then activates or manipulates the alternate mode activator to cause the alternate controller 104 to remotely transmit the collision avoidance command to the UAS 100. The UAS 100 receives or remotely accepts the collision avoidance command and in response thereto enters a safe mode, stops traveling along the path or track indicated by arrow 124, and optionally performs a safety maneuver.

In some embodiments, upon entering the safe mode in response to the collision avoidance command, the UAS 100 performs a safety maneuver by bringing its forward or lateral momentum to a stop or hovering in place (e.g., at a position before reaching the object 127). In this case, the safety observer 106 observes a situation where stopping forward momentum and hovering of the UAS 100 is deemed an action that would reduce the likelihood of a collision or future accident. Examples of such situations include, but are not limited to: 1) flying towards an obstacle while in coordinated flight; 2) a person enters the flight path (e.g., walks onto a movie/TV set or is out of position on stage where the UAS 100 could impact the person); 3) a visible mechanical issue or onboard fire occurs; 4) the UAS 100 appears to no longer be properly responding to the primary controller 103 and the remote PIC 105 needs to initiate a safe mode. (In some embodiments, the primary controller 103 includes an alternate mode activator for the remote PIC 105 to activate the safe mode.) In embodiments in which the UAS 100 is a fixed wing device, however, the UAS 100 cannot just stop and hover. Upon entering the safe mode, therefore, the fixed wing UAS 100 can fly in a station-keeping circle pattern. While the UAS 100 is hovering in place or flying in the station-keeping circle, it is the ultimate responsibility of the remote PIC 105, as the Pilot in Command, to assess the situation prior to resuming normal flight.

In some embodiments, upon entering the safe mode in response to the collision avoidance command, the UAS 100 performs an initial action prior to stopping or hovering in place. For example, the UAS 100 changes its altitude (gain or loss) or turns left or right prior to stopping or hovering in place, or while attempting to stop or hover in place, in response to the received collision avoidance command. In some embodiments, the alternate controller 104 has more than one alternate mode activator, each one causing transmission of a different collision avoidance command, each command causing the UAS 100 to respond differently when entering the safe mode. Thereby, the safety observer 106 is enabled to quickly select whichever alternate mode activator elicits the desired response by the UAS 100 that best suits the current situation, e.g., stop and hover without changing altitude, stop and hover with gain of altitude, stop and hover with loss of altitude, etc. Additionally, the duration of the initial action may be pre-programmed in the UAS 100 or the alternate controller 104. Also, for embodiments in which the UAS 100 is a fixed wing device, if the thrust is greater than the weight of the UAS 100, the UAS 100 may climb to a pre-determined altitude or by a predetermined amount before going into the station-keeping circle. On the other hand, if the thrust is less than the weight, the UAS 100 can perform an “Immelmann turn” to gain altitude (or some other aerobatic maneuver to gain altitude) and then go into the station-keeping circle. Alternatively, the fixed wing UAS 100 can simply lose altitude before going into the station-keeping circle. (In some embodiments, other responses, e.g., involving flight changes in any direction, are also enabled with multiple alternate mode activators.)

For example, if the object 127 is a bridge that spans the path indicated by arrow 124, and the safety observer 106 perceives the potential for a collision far enough ahead of time, then the safety observer 106 can select the alternate mode activator that issues the collision avoidance command that causes the UAS 100 to simply bring its lateral momentum to a stop. In this case, the UAS 100 ends up hovering in place without changing its altitude before it reaches the bridge object 127. On the other hand, if the alternate controller 104 has multiple alternate mode activators, and the safety observer 106 does not perceive the potential for a collision with the bridge object 127 until the UAS 100 is very close to it, then the safety observer 106 may determine that some initial action would reduce the likelihood of a collision, so the safety observer 106 can quickly select the alternate mode activator that issues the collision avoidance command that causes the UAS 100 to gain or lose altitude (or to turn left or right) before or while it comes to a stop and hovers. In this case, the UAS 100 ends up hovering in place above or below the bridge object 127. (In some embodiments, a command to stop following the normal path and a command to change altitude are generated by activation of separate alternate mode activators of the alternate controller 104.) In these examples, relatively rapid reaction by the safety observer 106 and relatively quick response by the UAS 100 are enabled without having to relay an alert to the remote PIC 105 or to rely on automatic collision detection and avoidance technology.

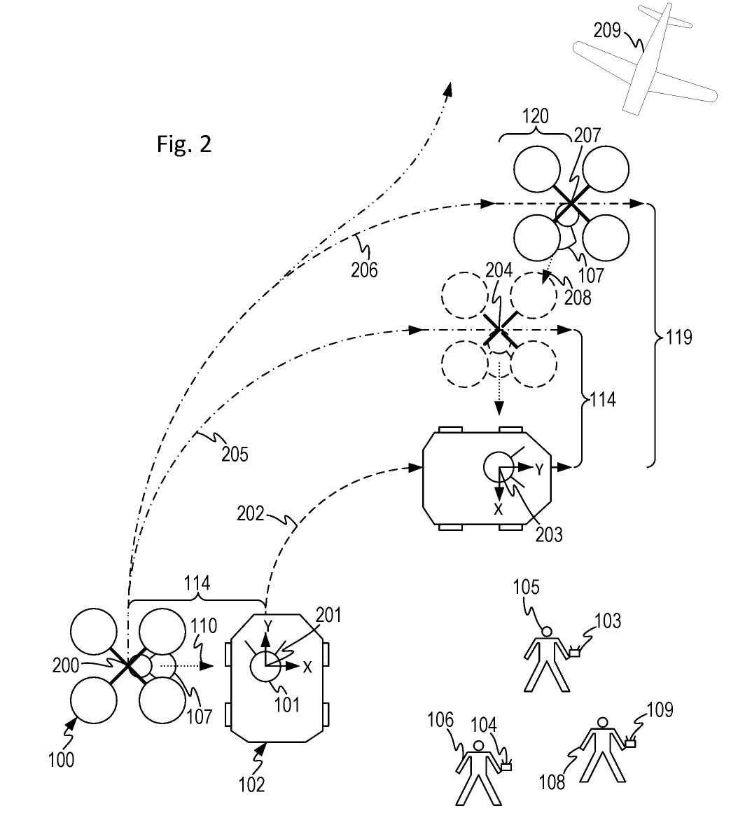

FIG. 2 shows another example situation in which the UAS 100 is operated relative to the external object tracker 101 in accordance with some embodiments. In this example, the UAS 100 is configured to follow the external object tracker 101, and thus the external object 102, as the external object tracker 101 moves with the external object 102 during a turn, or change in direction, of 90 degrees to the right by the external object 102. Again, the remote PIC 105 operates the UAS 100 under normal flight operations with the primary controller 103; the safety observer 106 is ready with the alternate controller 104 to immediately override the normal flight operations or take over control of the UAS 100 if needed; and the camera operator 108 uses the remote camera controller 109 to operate the camera 107 to point along arrow 110 toward the external object 102.

The rectilinear X-Y coordinate system is again shown centered on the external object tracker 101, with the Z-direction perpendicular to the plane of FIG. 2. Initially, when the UAS 100 and the external object tracker 101 are at positions 200 and 201, respectively, the UAS 100 has again been directed to fly relative to the external object tracker 101 with the first X-direction offset 114 (in a negative X direction), zero Y-direction offset, and any appropriate Z-direction (altitude, not shown) offset from the external object tracker 101. If the UAS 100 were to maintain this flight offset, while the external object tracker 101 turns with the external object 102 along a curved path indicated by arrow 202, then when the external object tracker 101 reached position 203, the UAS 100 would be at position 204. To make the corresponding turn within the same amount of time (along a curved path indicated by arrow 205), while maintaining the same offset relative to the X-Y coordinate system of the external object tracker 101, the UAS 100 would have to increase its overall speed, since its path is longer than that of the external object tracker 101, due to being on the outside of the curve. (Accelerations and decelerations of the UAS 100 to accommodate the speed changes may result in the curved path indicated by arrow 205 not being a perfect scaled-up version of the curved path indicated by arrow 202, so the UAS 100 is not necessarily always offset at exactly the same distance and direction from the external object tracker 101 when making the turn.)

However, in the illustrated example, when the UAS 100 is at the initial position 200, the remote PIC 105 manipulates one or more of the flight control devices (described below) of the primary controller 103, which causes the primary controller 103 to remotely transmit one or more flight control commands to the UAS 100. Similar to the example of FIG. 1, the flight control commands instruct the UAS 100 to change both the X and the Y coordinates of the UAS 100 relative to the external object tracker 101. The flight control commands thus cause the UAS 100 to change from a first state or position relative to the external object tracker 101 (where the UAS 100 was relatively close to and in line with the external object tracker 101) to a second state or position relative to the external object tracker 101 (where the UAS 100 is further away at the second X-direction offset 119 and slightly ahead at the first Y-direction offset 120 from the external object tracker 101). To make the offset adjustment relative to the X-Y coordinate system of the external object tracker 101, while also turning within the same amount of time (along a curved path indicated by arrow 206), the UAS 100 would have to increase its overall speed even more than for the curved path indicated by arrow 205, since its path is longer due to, not only being on the outside of the curve, but also ending up further away from the external object tracker 101. Thus, when the external object tracker 101 reaches position 203, the UAS 100 will be at position 207. Additionally, the camera operator 108 uses the remote camera controller 109 to adjust the camera 107 to point along arrow 208 toward the external object 102 to continue filming.

In the illustrated example, however, safety observer 106 perceives that another aircraft 209 (manned or unmanned) is potentially on a collision course with the UAS 100, if the UAS 100 were to continue on the curved path indicated by arrow 206. (Alternatively, the safety observer 106 perceives that the UAS 100 is on a collision course with a stationary object.) The safety observer 106 thus uses the alternate controller 104 to activate the alternate mode activator that issues a collision avoidance command to the UAS 100. In some embodiments, the alternate mode activator includes one or more flight control devices (described below), e.g., similar to some of the flight control devices of the primary controller 103 that the remote PIC 105 manipulates for normal flight control of the UAS 100. In some embodiments, the activation of the alternate mode activator includes manipulation of one or more of the flight control devices of the alternate controller 104.

As soon as the safety observer 106 manipulates the flight control device, the alternate controller 104 transmits the collision avoidance command along with an alternate flight control command. (In some embodiments, the collision avoidance command is the alternate flight control command. In some embodiments, the collision avoidance command and the alternate flight control command are generated by activation of separate alternate mode activators.) The alternate flight control command indicates a change in operation or flight direction/path/speed for the UAS 100. When the UAS 100 receives the collision avoidance command and the alternate flight control command, the UAS 100 stops travelling on the normal flight path dictated by the primary controller 103, and changes flight in accordance with the alternate flight control command. In this manner, the safety observer 106 immediately takes over full control of the UAS 100 in order to divert the UAS 100 from the potential collision course and onto a safe path with a change of lateral direction, altitude and/or speed. The safety observer 106 then serves as an alternate remote PIC and continues handling flight controls for the UAS 100 or returns flight control to the remote PIC 105. In this example, relatively rapid reaction by the safety observer 106 and relatively quick response by the UAS 100 are enabled without having to relay an alert to the remote PIC 105 or to rely on automatic collision detection and avoidance technology.

In some embodiments, whether the other aircraft 209 is another UAS or a manned aircraft, “safe flight corridors” are pre-programmed into the UAS 100. In some embodiments, “flight rules” (e.g., giving priority to manned aircraft) are also pre-programmed into the UAS 100. Alternatively, data for the corridors and flight rules are sent as a set of instructions from the primary controller 103 or the alternate controller 104 through a communication network.

In a situation where the other aircraft 209 is another UAS, and the safety observer 106 perceives a potential collision, the safety observer 106 triggers an air interaction safe mode (a UAS vs. UAS safe mode) by activation of one of the alternate mode activators of the alternate controller 104. Upon triggering the air interaction safe mode, if both UASs (100 and 209) have the capability, then both UASs broadcast their velocity vectors to each other (e.g., through pre-determined channels, group communication, etc.). Additionally, the alternate controller 104 generates and transmits unique commands to both UASs to reduce the likelihood of collision. In some embodiments, the unique command technique is similar to the TCAS (Traffic Alert and Collision Avoidance System) used by commercial aircraft. In some embodiments, as part of the Collision Avoidance implementation, the safe flight corridors are implemented, which puts the onus of maneuvering out of the way on the UAS (100 or 209) which is in the less restrictive environment. For example, if the two UASs (100 and 209) are flying towards each other down a wooded path one below the other, with an opening to the air above, the UAS which has more immediate access to the open air above is given the more aggressive response (i.e., greater change in operation), while the UAS that is limited both below and to either side is given the less aggressive response.

In some embodiments, the safety observer 106 monitors a display of multiple UASs (e.g., working in conjunction with each other to accomplish a task), with their location and velocity vectors. When seeing a situation where two or more UASs need a collision avoidance safe mode to reduce the likelihood of a collision, the safety observer 106 selects those UASs and initiates a UAS vs. UAS safe mode.

Upon completion of the generated unique command, all of the UASs (e.g., 100 and 209) involved terminate their forward momentum, hover, and wait for their remote pilot (e.g., the PIC 105) to reinstate control. In the unique situation where the primary controller 103 of one of the UASs initiated the safe mode, and the collision avoidance system did not deem that the UAS (e.g., 100) associated with that primary controller 103 needed to alter course, then the UAS 100 may continue normal flight mode under the control of the primary controller 103. In this manner, the primary controller 103 of one UAS 100 can cause a different UAS to go into safe mode. Alternatively, the alternate controller 104 for one UAS 100 can cause the other UAS to go into safe mode. In some embodiments, a safe mode command can affect one or more of the UASs when there is more than one UAS.

In a situation where the other aircraft 209 is a manned aircraft, the safety observer 106, the remote PIC 105, or the PIC of the manned aircraft 209 may perceive a situation where the UAS 100 is about to interfere with the flight of the manned aircraft 209 and trigger an air interaction safe mode (a UAS vs. manned aircraft safe mode). In some embodiments, therefore, the alternate controller 104, the primary controller 103, or compatible equipment operated by the PIC in the manned aircraft 209 can be used to initiate the safe mode. In this case, the compatible equipment in the manned aircraft 209 transmits the velocity vector of the manned aircraft 209 to the UAS 100. In response to receiving the velocity vector, the UAS 100 flies in a direction away from the manned aircraft 209. For example, if the manned aircraft 209 (e.g., a helicopter or airplane) and the UAS 100 are being used for cinematography work (e.g., a special effect, an action sequence, etc.), and the UAS 100 encroached too close to the flight path of the manned aircraft 209, then the PIC of the manned aircraft 209 can initiate the safe mode. In this situation, the UAS 100 receives the velocity vector of the manned aircraft 100 and responds by flying in a manner that avoids collision with the manned aircraft 209. In some embodiments, the velocity vector of the manned aircraft 209 is received by the UAS 100 directly from the manned aircraft 209. In some embodiments, the UAS 100 receives this information through a relay ground station, a secondary set of dynamic sensors on the manned aircraft 209, the alternate controller 104, the primary controller 103, or other appropriate means.

In some embodiments, flight rules can also be used in the interaction between the manned aircraft 209 and the UAS 100, even with safe flight corridors established. For example, if a command is received (e.g., from the alternate controller 104, the primary controller 103, or the manned aircraft 209) to fly away from the manned aircraft 209, but the flight vector would impede upon or cross the edge of a safe flight corridor, the UAS 100 may violate the safe flight corridor due to the flight rules established. In some embodiments, other flight rules limit the extent to which the UAS 100 will encroach upon the edges of the flight corridors. For example, if one of the boundaries of a flight corridor is a historic or religious site and a collision would do permanent damage to it, then the UAS 100 may violate the general flight rule against impacting the ground prior to encroaching on a historic or religious site.

In some embodiments, the UAS vs. manned aircraft safe mode is used by commercial aircraft. Thus, if the UAS 100 is flying in congested airspace, then any pilot of the commercial aircraft, perceiving that the UAS 100 was too near, could initiate the safe mode and transmit the collision avoidance command along with the velocity vector of the commercial aircraft, so that the UAS 100 can stay clear of the manned aircraft. In some embodiments, all UASs to be flown in congested airspace are required (e.g., by FAA action, or other governing Aviation body) to be installed with the safe mode capabilities described herein, so that the PIC of any manned aircraft can initiate a safe mode at any time to ensure that UASs within a predetermined radius stay clear. In some embodiments, all UASs within broadcast range of the commercial aircraft receive the safe mode signal or collision avoidance command and respond in a manner that avoids a collision with the commercial aircraft.

In some embodiments, instead of both X and Y changes to the offset being executed at the same time in the above examples, the changes may be executed sequentially—one before the other as appropriate. In some embodiments, the implementation of the changes to the operation of the UAS 100 can be performed in any manner that results in a smooth, safe, and/or efficient transition as defined by preprogrammed instructions or transmitted by the primary controller 103.

In some embodiments, the external object tracker 101 maintains the X-Y-Z coordinate system relative to itself, and the UAS 100 maintains another X-Y-Z coordinate system relative to itself. Commands received by the UAS 100 from the primary controller 103 to follow or shadow the path of the external object tracker 101 (as indicated by data received from external object tracker 101 in the coordinate system of the external object tracker 101) at a particular offset (as indicated by data received from the primary controller 103) are translated by the UAS 100 into its own coordinate system.

In some embodiments, the external object tracker 101 maintains its location, vector and orientation data relative to the ground or GPS and compass type data and transmits this data to the UAS 100. The UAS 100 determines its own location, vector and orientation data relative to the ground or GPS and compass type data (to determine its flight path) based on the data received from the external object tracker 101 and the offset data received from the primary controller 103.

In some embodiments, the UAS 100 is preprogrammed with waypoint data defining its path provided from the primary controller 103. For example, if the path of the external object 102 is known ahead of time, then the path of the UAS 100 is determined based on a desired offset from the path of the external object 102. The speed (or location within its path) of the UAS 100 is then based on the speed (or location within its path) of the external object tracker 101 as indicated by the data received by the UAS 100 from the external object tracker 101.

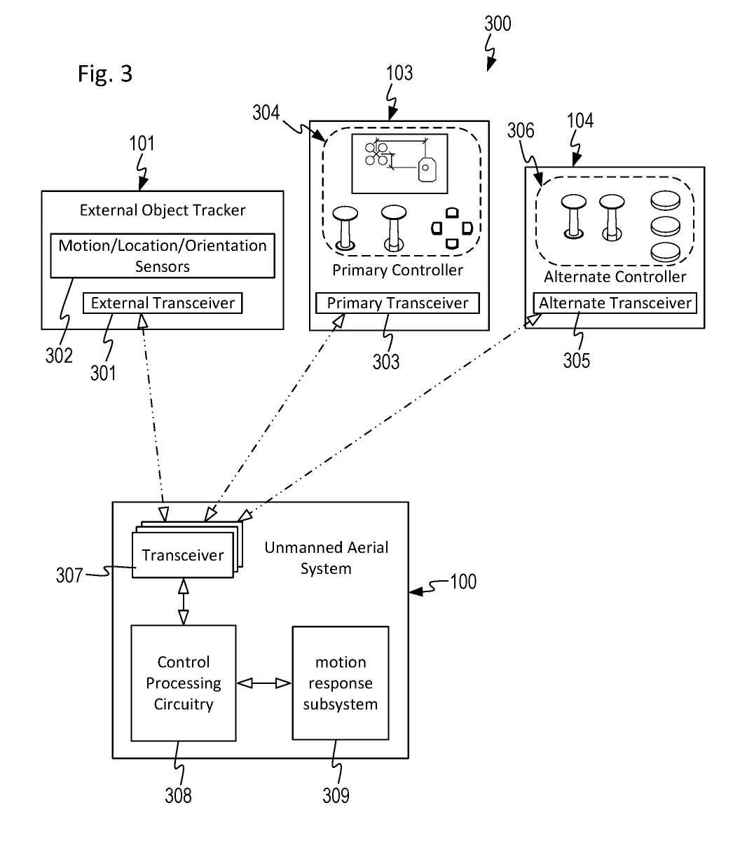

FIG. 3 shows a UAS control system 300 including the UAS 100, the external object tracker 101, the primary controller 103, and the alternate controller 104, in accordance with one or more example embodiments. The illustrated configuration of components for these devices is provided for ease of illustrative and explanatory purposes. Other embodiments may incorporate other combinations of components and variations on the functions thereof.

The external object tracker 101 generally includes an external transceiver 301 and various sensors 302 for tracking or determining data or information indicative of the motion, location, orientation, position, velocity, etc. of the external object tracker 101. The external transceiver 301 is configured to remotely or wirelessly transmit this external object data to the UAS 100. The external object tracker 101 is typically mounted on, disposed within, carried by, or otherwise physically associated with the external object 102 (FIGS. 1 and 2). In some embodiments, the external object tracker 101 and the external transceiver 301 are separate from the external object 102, e.g., as a controller, sensor box or other device carried by a user riding in or on the external object 102. In some embodiments, the external object tracker 101 (or just the external transceiver 301) is incorporated into the external object 102, for example, as part of a vehicle's built-in sensor and communication system. The external object 102 is generally in communication with the UAS 100 through the external transceiver 301 of the external object tracker 101.

The primary controller 103 generally comprises one or more wireless-enabled remote controls, computers, control panels, mobile devices, cellular telephones, smart phones, notepad computers, laptop computers, etc. The primary controller 103 generally has a primary transceiver 303 and a variety of flight control devices 304. The flight control devices 304 generally include any appropriate types and combinations of devices configured for generating flight control commands and/or data and receiving feedback for controlling the UAS 100, such as, but not limited to, omni-directional joysticks, bidirectional joysticks, toggle switches, button switches, button panels, alphanumeric keypads, touch screens, display screens, LEDs, etc. When the remote PIC 105 (FIGS. 1 and 2) manipulates, or activates, any of the flight control devices 304, the primary controller 103 generates the flight control commands, which the primary transceiver 303 transmits to the UAS 100. In other words, the primary controller 103 generates the commands based on user-generated input.

The alternate controller 104 represents one or more control units. For example, a single safety observer 106 can use a single alternate controller 104 to place the UAS 100 into safe mode, or multiple safety observers 106 can use multiple alternate controller 104, each of which can independently place the UAS 100 into safe mode. The alternate controller 104 generally comprises one or more wireless-enabled remote controls, computers, control panels, mobile devices, cellular telephones, smart phones, notepad computers, laptop computers, etc. The alternate controller 104 generally has an alternate transceiver 305 and a variety of flight control devices or alternate mode activators 306. Although FIG. 3 shows five alternate mode activators 306 (two joysticks and three buttons) the flight control devices or alternate mode activators 306 generally include any appropriate number, types and combinations of devices for generating one or more immediate collision avoidance commands and/or flight control commands/data and receiving feedback for controlling the UAS 100, such as, but not limited to, omni-directional joysticks, bidirectional joysticks, toggle switches, button switches, button panels, alphanumeric keypads, touch screens, display screens, LEDs, etc. In some embodiments, the alternate controller 104 is a complete duplicate of the primary controller 103, including all flight control devices 304, to which may be added one or more alternate mode activators. In some embodiments, the alternate controller 104 has a subset of the functions and flight control devices 304 of the primary controller 103. In some embodiments, the alternate controller 104 has only a minimum number of control devices or alternate mode activators needed for generating one or more collision avoidance commands. When the safety observer 106 (FIGS. 1 and 2) manipulates, or activates, any of the flight control devices or alternate mode activators 306, the alternate controller 104 generates one or more of the collision avoidance commands and optional alternate flight control commands, which the alternate transceiver 305 transmits to the UAS 100. In other words, the alternate controller 104 generates the commands based on user-generated input. In some embodiments, the alternate controller 104 includes a display screen with which the safety observer 106 can observe the UAS 100, so that the safety observer 106 can use the display screen to replace, supplement or augment line-of-sight observations for keeping watch over the UAS 100. In some embodiments, the display screen is provided on another device (e.g., a computer, a mobile device, a cellular telephone, a smart phone, a notepad computer, a laptop computer, a stand-alone monitor, a control panel, etc.) separate from the alternate controller 104. In some embodiments, the safety observer 106 keeps watch over multiple UASs 100 (e.g., that are being operated at the same time) by line of sight and/or via the display screen. In some embodiments, the safety observer 106 uses more than one of the display screens or multiple images on a single display screen to provide multiple angle views of the UAS 100.

Additionally, in some embodiments, the user generated input for the primary controller 103 and/or the alternate controller 104) can select a coordinate system to be used by the primary controller 103 and/or the alternate controller 104. This coordinate system can be the coordinate system that will be used by the remote PIC 105 and/or the safety observer 106 when generating the flight control commands with the primary controller 103 and/or the alternate controller 104.

The UAS 100 generally includes at least one transceiver 307, a control processing circuitry 308, and a motion response subsystem 309. The UAS 100 wirelessly receives the various commands or data from the external object tracker 101, the primary controller 103, and the alternate controller 104 through the transceiver 307. These commands or data can replace or supplement existing or preprogrammed commands or data in the UAS 100. In general, the control processing circuitry 308 is configured to receive the flight control commands or data and interpret the commands or data to produce one or more motion control signals that implement the flight controls of the commands or data. (In some embodiments, the flight control commands received from the primary controller 103 are interpreted only in the absence of a collision avoidance command from the alternate controller 104.) The motion response subsystem 309 is configured to receive the motion control signals and, in response thereto, to cause the UAS 100 to travel along a desired path in accordance with the flight control commands. Additionally, the control processing circuitry 308 is further configured to receive the collision avoidance command or alternate flight control commands from the alternate controller 104 and, in response thereto, to produce one or more motion control signals that cause the motion response subsystem 309 to stop the unmanned aerial vehicle from traveling along the desired path. The UAS 100 also transmits various feedback signals or data, as appropriate, through the transceiver 307 to the external object tracker 101, the primary controller 103, and/or the alternate controller 104.

Thus, the external object tracker 101, the primary controller 103, the alternate controller 104, or any combination thereof provide the various commands and/or data to the UAS 100. In some embodiments, the data from the external object tracker 101, for example, is combined with the flight control commands (from the primary controller 103 and/or the alternate controller 104) to cause changes in the relative position or motion between the external object tracker 101 and the UAS 100, so that the UAS 100 can be configured to follow the external object tracker 101.

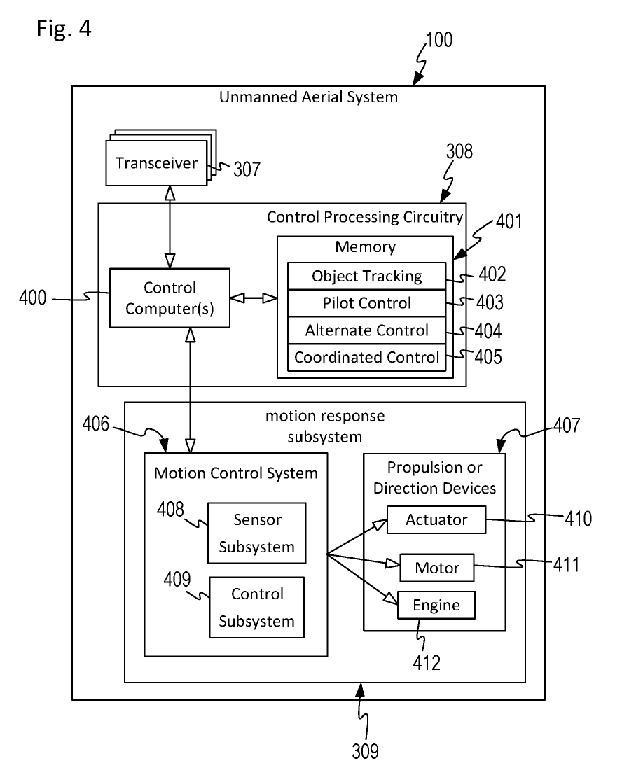

FIG. 4 shows additional details of the UAS 100, including one or more of the transceiver 307, the control processing circuitry 308, and the motion response subsystem 309, in accordance with one or more example embodiments. The illustrated configuration of components for the UAS 100 is provided for ease of illustrative and explanatory purposes. Other embodiments may incorporate other combinations of components and variations on the functions thereof. For example, some components or functions of the motion response subsystem 309 may be considered part of the control processing circuitry 308, and vice versa.

In some embodiments, the transceiver 307 represents one or more appropriate wired or wireless communication devices for sending and/or receiving data or other electromagnetic signals. In some embodiments, the transceiver 307 enables direct connection (such as a tether for a remotely operated undersea system), radio frequency (such as the transmitter and receiver pair used to control a remotely controlled airplane), or laser/light (such as Line-Of-Sight Beam Riding) bidirectional communications techniques. In some embodiments the transceiver 307 is capable of one-way communication only, for example, as a receiver or transmitter.

In some embodiments, the control processing circuitry 308 generally represents or includes one or more control computers or processors 400 and one or more computer memory units 401. The transceiver 307 is connected to the control computer 400 for the sending and receiving of the data for the various commands.

The control computer 400 represents one or more computers, microprocessors, etc. The control computer 400 interprets or processes signals going to or from the transceiver 307. For example, some signals from the transceiver 307 are interpreted by the control computer 400 into the external object data, the flight control commands or the collision avoidance commands for the UAS 100. Also, in some embodiments, commands or data from the control computer 400 are sent to the transceiver 307 to be transmitted to an external device, e.g., the external object tracker 101, the primary controller 103, or the alternate controller 104. Additionally, the control computer 400 receives sensor and feedback data from the motion response subsystem 309. Based on the external object data, the flight control commands, the collision avoidance commands and/or the sensor and feedback data, the control computer 400 generates the motion control signals that are provided to the motion response subsystem 309 to implement the flight control command or the response to the collision avoidance command

The computer memory unit 401 represents one or more physical memory devices, including non-transitory storage media, RAM, ROM, DRAM, SDRAM, magnetic memory, flash memory, optical memory, etc. In some embodiments, the computer memory unit 401 generally stores programs and data that are executed by the control computer 400 to perform the functions thereof. In some embodiments, the programs and data include an external object tracking module 402, a pilot control module 403, an alternate (or safe mode) control module 404, and a coordinated control module 405, among other appropriate programs and data not shown for simplicity. The external tracking module 402 generally enables the control computer 400 to interpret and process commands and data received from the external object tracker 101 in response to the various sensors 302 detecting movement or changes in location, orientation or speed, so that the UAS 100 can follow the external object tracker 101 during normal flight operations. The pilot control module 403 generally enables the control computer 400 to interpret and process commands and data received from the primary controller 103 in response to manipulations of the flight control devices 304 by the remote PIC 105, so that the UAS 100 can travel a desired path or trajectory and/or change its position or orientation offset relative to the external object tracker 101 during normal flight operation. The alternate control module 404 generally enables the control computer 400 to interpret and process commands and data received from the alternate controller 104 in response to manipulations of the flight control devices or alternate mode activators 306 by the safety observer 106 in order to override the normal flight operations to avoid dangerous conditions or put the UAS 100 in safe mode. The coordinated control module 405 generally enables the control computer 400 to coordinate the external object data, the flight control commands, the collision avoidance commands and/or the sensor and feedback data to generate the motion control signals for the motion response subsystem 309. In addition, the control computer 400 maintains parameters or data in the computer memory unit 401 for the X-Y-Z offset relative to the external object tracker 101, so that the control computer 400 can determine the location and orientation it is supposed to have when it receives the external object data or flight control data.

In some embodiments, the motion response subsystem 309 generally represents or includes a motion control system 406 and propulsion or direction devices 407. The motion control system 406 generally represents or includes a sensor subsystem 408 and a control subsystem 409. The propulsion or direction devices 407 generally represent or include various actuators 410, motors 411, engines 412, etc.

In some embodiments, the sensor subsystem 408 generally represents or includes a variety of appropriate sensor devices and associated circuitry, e.g., a GPS sensor, a barometer, a compass, and an inertial measurement device such as a gyroscope, among other potential motion, direction and/or location components. The sensor subsystem 408 generally produces data for determining the location, orientation and velocity of the UAS 100. In some embodiments, image processing, and/or sonar methods can replace, or be used in addition to, the GPS sensor and inertial measurement device. In some embodiments, an external LIDAR and/or radar can be used to augment, or be used in place of some parts of the sensor subsystem 408. The sensor subsystem 408 is connected to the control computer 400 in order to provide at least some of the sensor data (e.g., location data, etc.) to the control computer 400 for use in managing flight operations by the coordinated control module 405.

The control subsystem 409 generally represents any appropriate circuitry for receiving and processing the motion control signals from the control computer 400 and the sensor data from the sensor subsystem 408. With this data or signals, the control subsystem 409 generates signals or instructions for the propulsion or direction devices 407 to produce the movements of the UAS 100.

The actuator 410 generally represents or includes various ailerons, breaks, rotors, etc. that are appropriate for the type of vehicle of the UAS 100. The motor 411 generally represents or includes any appropriate electro-mechanical devices that can drive some of the various rotors, propellers, wheels, etc. that are appropriate for the type of vehicle of the UAS 100. The engine 412 generally represents or includes any appropriate mechanical devices that can convert chemical energy into heat energy, e.g., an internal combustion engine, to drive some of the rotors, propellers, wheels, etc. In some embodiments, the engine 412 directly provides thrust for the UAS 100 by, for example, expelling gas, expelling fluids, etc. The control of the actuator 410, the motor 411, and/or the engine 412 is provided by the commands or signals from the motion control system 406. In some embodiments, feedback data from the actuator 410, the motor 411, and/or the engine 412 is provided to the motion control system 406 and/or the control computer 400 for purposes of providing feedback of the operation, movement or performance of the UAS 100.

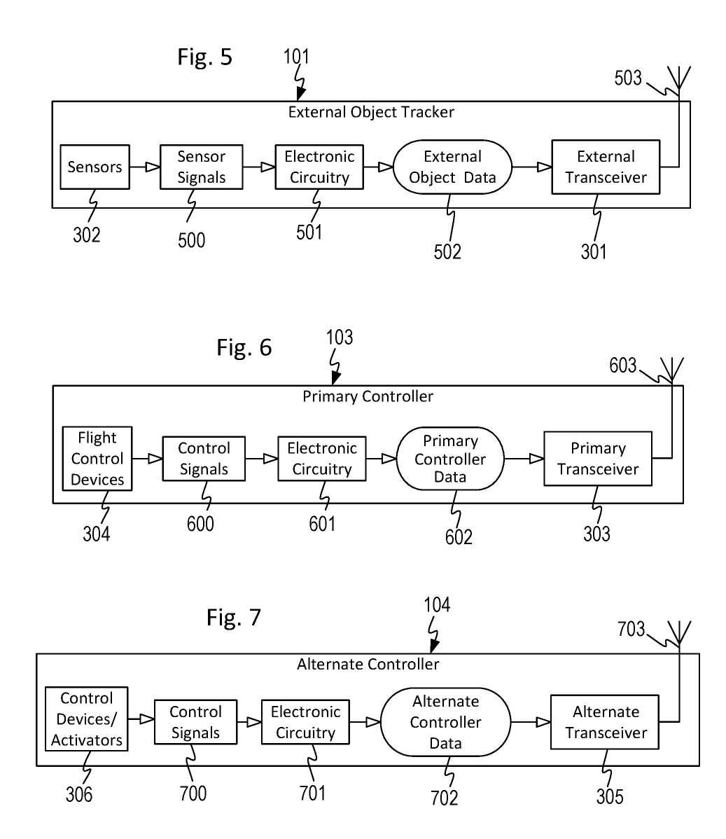

FIGS. 5-8 show an example flow of data during operations of the components of the UAS control system 300. The illustrated order of operations, flow of data, and particular components are provided for ease of illustrative and explanatory purposes. Other embodiments may incorporate other orders of operations and data flows, e.g., due to different combinations of components and variations on the functions thereof.

FIG. 5 shows an example flow of data during operations of the external object tracker 101, in accordance with one or more example embodiments. In this example, the various sensors 302 generate sensor signals 500 in response to movement of the external object tracker 101. Electronic circuitry 501 converts the raw sensor signals 500 into useable external object data 502. The external transceiver 301 formats and transmits packets of the external object data 502 through an antenna 503 to the UAS 100.

FIG. 6 shows an example flow of data during operations of the primary controller 103, in accordance with one or more example embodiments. In this example, the flight control devices 304 generate control signals 600 in response to manipulations by the remote PIC 105. Electronic circuitry 601 converts the raw control signals 600 into useable primary controller data 602, including flight control commands. The primary transceiver 303 formats and transmits packets of the primary controller data 602 through an antenna 603 to the UAS 100.

FIG. 7 shows an example flow of data during operations of the alternate controller 104, in accordance with one or more example embodiments. In this example, the flight control devices or alternate mode activators 306 generate control signals 700 in response to manipulations or activations by the safety observer 106. Electronic circuitry 701 converts the raw control signals 700 into useable alternate controller data 702, including the collision avoidance commands and the optional alternate flight control commands. The alternate transceiver 305 formats and transmits packets of the alternate controller data 702 through an antenna 703 to the UAS 100.

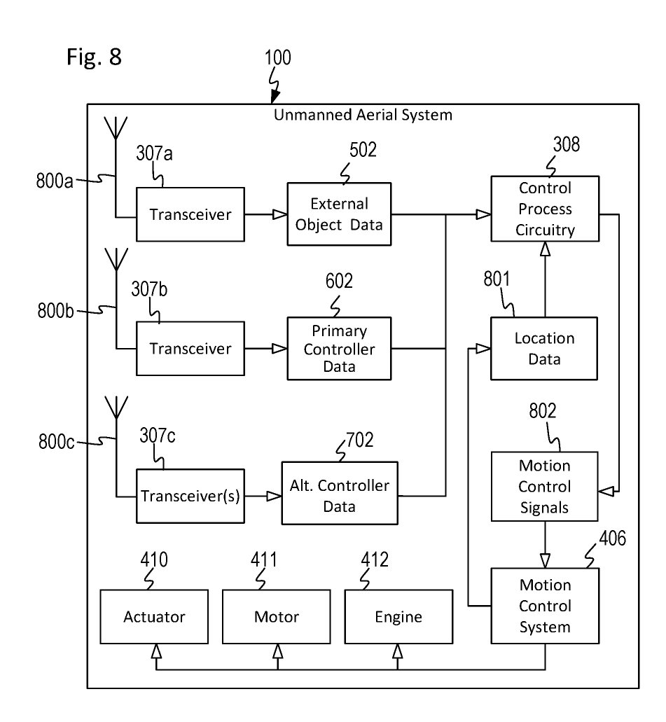

FIG. 8 shows an example flow of data during operations of the UAS 100, in accordance with one or more example embodiments. In this example, the external object data 502, the primary controller data 602, and the alternate controller data 702 are received through one or more antennas 800a-c and one or more of the transceiver 307a-c. Additionally, while shown as a single transceiver 307c and antenna 800c pair, multiple transceivers 307c and antennas 800c can be utilized, each with its own alternate controller data 702, for communicating with multiple alternate controllers 104 handled by multiple safety observers 106. Additionally, the sensor subsystem 408 of the motion control system 406 produces location data 801 that indicates the current location of the UAS 100. The control processing circuitry 308 receives the external object data 502, the primary controller data 602, the alternate controller data 702, and the location data 801. With this data, the control processing circuitry 308 produces motion control signals 802. The motion control system 406 receives the motion control signals 802. With the motion control signals 802 (and any appropriate data from the sensor subsystem 408), the motion control system 406 generates the commands or signals that are applied to the actuator 410, the motor 411, and/or the engine 412. In response, the actions of the actuator 410, the motor 411, and/or the engine 412 adjust the operation or flight of the UAS 100.

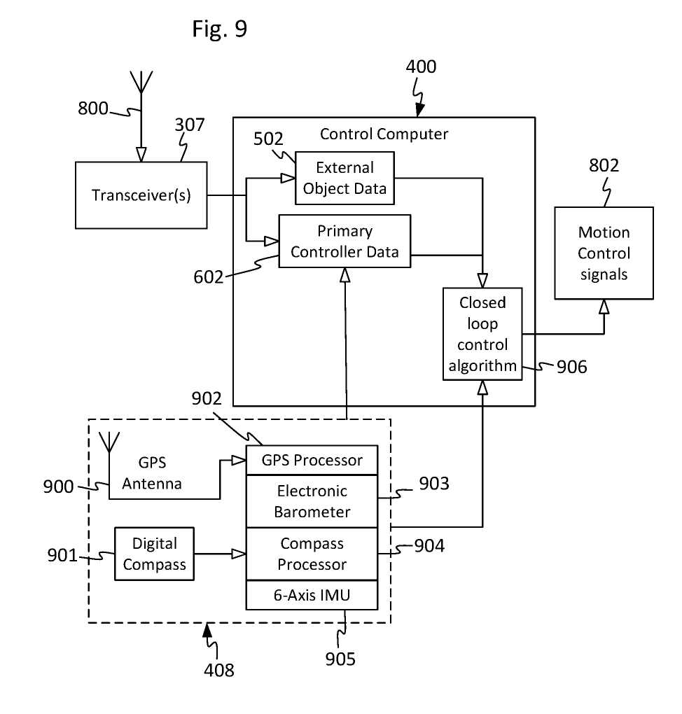

FIG. 9 shows an example flow of data during operations of the control computer 400 and associated components for the normal flight mode, in accordance with one or more example embodiments. In this example, the transceiver(s) 307 for communicating with the primary controller 103 and the external object tracker 101 receives the primary controller data 602 (e.g., flight control commands) and the external object data 502 (e.g., location and orientation data) through the antenna(s) 800 and provides this data 602 and 502 to the control computer 400. In some embodiments, the data 602 and 502 are received through a data link (e.g., utilizing the 2400 MHz ISM Band). The primary controller data 602 typically takes the form of roll/pitch/yaw/throttle data and mode selection data. Additional body dynamics sensor components of the sensor subsystem 408, such as a GPS antenna 900 and a digital compass 901, a GPS processor 902, an electronic digital barometer 903, a compass processor 904, and a 6-Axis IMU (inertial measurement unit with 3 axis rate-gyroscope and 3 axis accelerometer) 905, receive or generate additional sensor signals or data. Thus, the control computer 400 operates with inertial measurement data, barometric pressure data, compass direction data, and/or GPS (global positioning satellite) type location data to ensure that it is at a desired location, oriented in a desired direction and traveling on a desired path. (In some embodiments, the GPS processor 902, the electronic digital barometer 903, the compass processor 904, and the IMU 905 are part of the control computer 400, but the GPS antenna 900 and the digital compass 901 are external to the control computer 400 due to magnetic interference issues.)

The control computer 400 combines the additional sensor signals or data with the primary controller data 602 and the external object data 502 and processes this data (depending on the current flight mode) through a closed loop control algorithm 906 (e.g., the external tracking module 402, pilot control module 403, and the coordinated control module 405) to generate the motion control signals 802 to maintain stability of the UAS 100 and execute the flight control commands. For example, the motion control signals 802 include a set of commands or signals (e.g., RPM commands) for each of the actuator 410, the motor 411, and/or the engine 412. In this embodiment, the closed loop control algorithm 906 is shown as part of the control computer 400 for the ease of illustrative and explanatory purposes. Other embodiments, on the other hand, may incorporate the closed loop control algorithm 906 as part of the motion control system 406 or the motion response subsystem 309. Still other embodiments may incorporate the closed loop control algorithm 906 as part of the control processing circuitry 308, independent of the control computer 400.

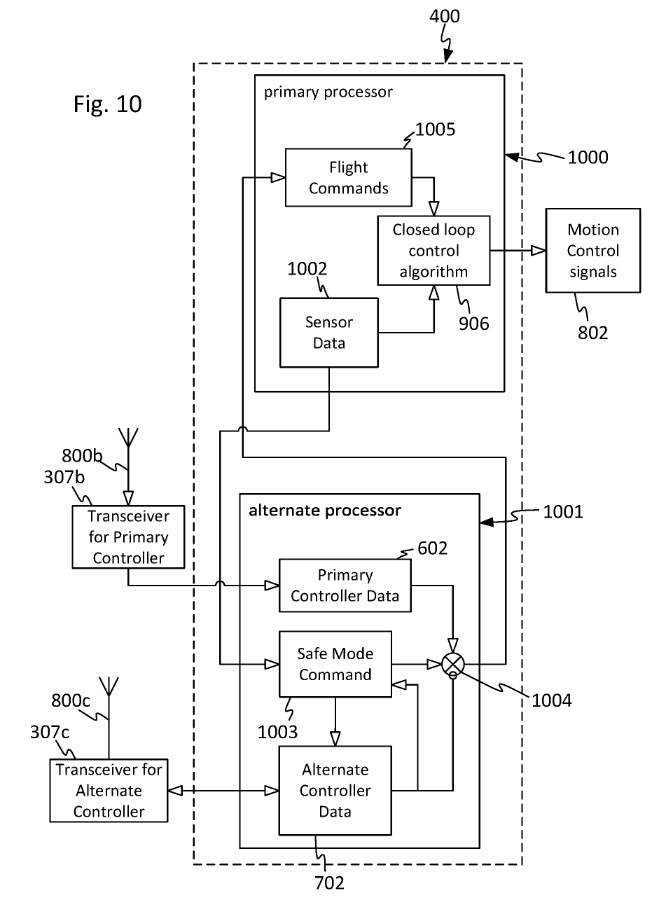

FIG. 10 shows an example flow of data during operations of the control computer 400 and associated components for the alternate flight mode or safe mode, in accordance with one or more example embodiments. In the illustrated embodiment, a primary processor 1000 and an alternate (safe mode) processor 1001 form the control computer 400. In this example, the primary controller data 602 is received by the alternate processor 1001 through the antenna 800b and the transceiver 307b that communicate with the primary controller 103. Additionally, the alternate controller data 702 (e.g., safe mode instructions and/or collision avoidance commands) is received by the alternate processor 1001 through the antenna 800c and the transceiver 307c that communicate with the alternate controller 104. (In some embodiments, there are independent transmit and receive data links utilizing any number of the ISM bands.) Additionally, sensor data 1002 is provided through the primary processor 1000 as described above with respect to FIG. 9 for elements 900-905.

With the alternate controller data 702 and the sensor data 1002 (and optionally data from other safe mode flight processors), the alternate processor 1001 creates safe mode commands 1003, which indicate or execute the desired type of safe mode or the appropriate safe mode flight operations. In some embodiments, the safe mode commands are in the form of roll/pitch/yaw/throttle and mode selection signals or data that cause the UAS 100 to perform the safe mode operations, e.g., hover, change altitude, etc. In some embodiments, the alternate processor 1001 generates a velocity vector of the UAS 100 to be sent back through the transceiver 307c to the alternate controller 104 and/or to be broadcast to other nearby UASs or a central receiving station. In some embodiments, the alternate processor 1001 utilizes the velocity vector to coordinate safe mode flight operations with any other safe mode flight processors or computers (e.g., in the other UASs or a central computing system) to perform TCAS-like avoidance calculations.

The safe mode commands 1003 and the primary controller data 602 are applied to a switch 1004 in the alternate processor 1001. During the normal flight mode (i.e., when no alternate controller data 702 has been received, and the UAS 100 operates under control of the primary controller 103) the alternate processor 1001 controls the switch 1004 to select the primary controller data 602 to pass through to the primary processor 1000. During the alternate flight mode or safe mode (i.e., when the alternate controller data 702 has been received) the alternate processor 1001 controls the switch 1004 to select the safe mode commands 1003 to pass through to the primary processor 1000.

Thus, the primary controller data 602 is intercepted by the alternate processor 1001, and during the normal flight mode the primary controller data 602 is directly passed through to the primary processor 1000 to be used as flight commands 1005 for operating the UAS 100. During the alternate flight mode, on the other hand, the primary controller data 602 is bypassed, so the safe mode commands 1003 are passed through to the primary processor 1000 to be used as the flight commands 1005 for operating the UAS 100. The external object data 502 is also received by the primary processor 1000, as described above with respect to FIG. 9, but is omitted in FIG. 10 for simplicity. The primary processor 1000 thus performs as described above for the control computer 400 with respect to FIG. 9, using either the primary controller data 602 or the safe mode commands 1003, along with the external object data 502, in the closed loop control algorithm 906 to generate the motion control signals 802.

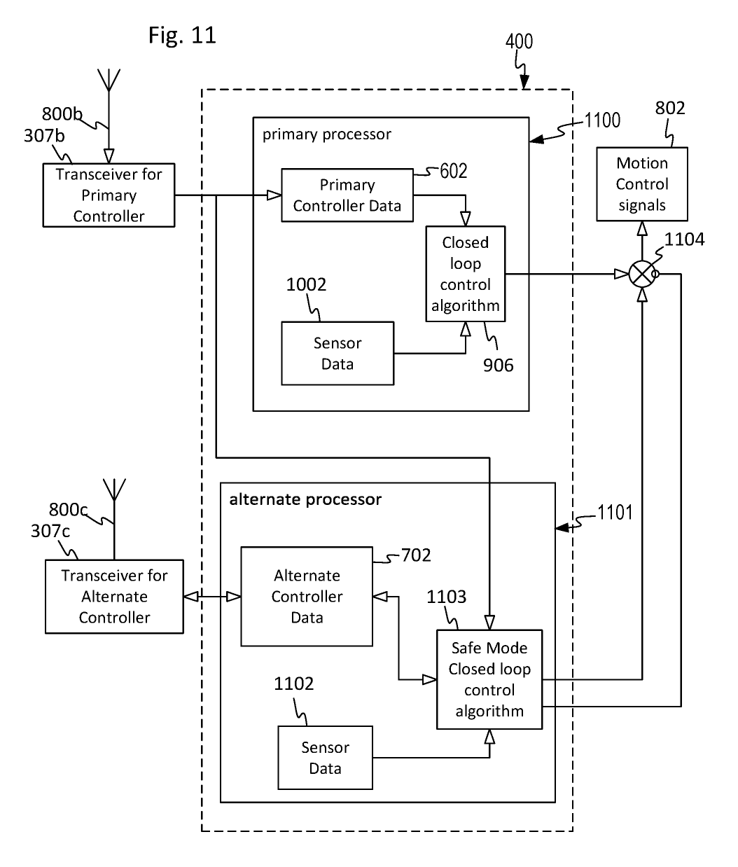

FIG. 11 shows another example flow of data during operations of the control computer 400 and associated components for the alternate flight mode or safe mode, in accordance with one or more alternative example embodiments. In the illustrated embodiment, a primary processor 1100 and an alternate (safe mode) processor 1101 form the control computer 400. In some embodiments, the alternate processor 1101 is a redundant navigation computer within the control computer 400.

In this example, the primary controller data 602 is received by the primary processor 1100 through the antenna 800b and the transceiver 307b that communicate with the primary controller 103. Additionally, the sensor data 1002 is provided to the primary processor 1100 as described above with respect to FIG. 9 for elements 900-905. On the other hand, the alternate controller data 702 (e.g., safe mode instructions and/or collision avoidance commands) is received by the alternate processor 1101 through the antenna 800c and the transceiver 307c that communicate with the alternate controller 104. Also, an additional sensor subsystem (not shown, but similar to 408) associated with the alternate processor 1101 provides similar sensor data 1102 to the alternate processor 1101 as described above with respect to FIG. 9 for elements 900-905. Furthermore, the external object data 502 is also received by the primary processor 1100 and optionally by the alternate processor 1101, as described above with respect to FIG. 9, but is omitted in FIG. 11 for simplicity.

During the normal flight mode, and similar to the above description with respect to FIG. 9, the primary processor 1100 combines the sensor data 1002 with the primary controller data 602 and the external object data 502 (not shown) and processes this data through the closed loop control algorithm 906 to generate the motion control signals 802 to maintain stability of the UAS 100 and execute the flight control commands desired by the remote PIC 105. During the alternate flight mode or safe mode, on the other hand, the alternate processor 1101 combines the sensor data 1102 with the alternate controller data 702 (and optionally the external object data 502) and processes this data through a safe mode closed loop control algorithm 1103 (e.g., similar to 906) to generate the motion control signals 802 to maintain stability of the UAS 100, perform the safe mode operations, e.g., hover, change altitude, etc., and optionally execute the alternate flight control commands desired by the safety observer 106. In some embodiments, the safe mode closed loop control algorithm 1103 uses the internal velocity vector and coordinates with other safe mode flight processors or computers to perform the TCAS-like avoidance calculations.

The motion control signals 802 generated by the primary processor 1100 and the alternate processor 1101 are applied to a switch 1104. During the normal flight mode (i.e., when no alternate controller data 702 has been received, and the UAS 100 operates under control of the primary controller 103) the alternate processor 1101 controls the switch 1104 to select the motion control signals 802 generated by the primary processor 1100 to pass through to the motion control system 406. During the alternate flight mode or safe mode (i.e., when the alternate controller data 702 has been received) the alternate processor 1101 controls the switch 1104 to the motion control signals 802 generated by the alternate processor 1101 to pass through to the motion control system 406. In some embodiments, a signal similar to that which controls the switch 1104 is also applied to the primary processor 1100 to put it into a non-operating mode, since its output is redundant.

In some embodiments, a failure or malfunction in the primary processor 1100 will not affect the alternate processor 1101, thus enabling a redundant system in the event of such failure of the primary processor to function properly, wherein flight control of the UAS 100 is maintained through the alternate controller 104 and the alternate processor 1101. In some embodiments, the primary controller 103 can communicate with the alternate processor 1101 (e.g., through the same or another transceiver 307b or c and antenna 800b or c), so the remote PIC 105 can continue to operate the UAS 100 in the event of a failure in the primary processor 1100, instead of having to turn flight control over to the safety observer 106. Thus, in the unique case where there is an issue with the primary processor 1100 (e.g., a warning that the primary processor 1100 is entering degraded performance, e.g., loss of one of the body dynamics sensor components of the sensor subsystem 408), but the UAS 100 can remain in normal flight mode, the remote PIC 105 triggers a switch through the primary controller 103 from the primary processor 1100 to the alternate processor 1101. In this case, the UAS 100 does not go into the alternate flight mode or safe mode, but continues normal flight under the control of the primary controller 103. In some embodiments, if the primary controller 103 causes a switch from the primary processor 1100 to the alternate processor 1101, but the normal flight mode cannot be continued for some reason, the alternate flight mode or safe mode can be initiated by the UAS 100.

In some embodiments, once the safe mode action or operations are complete the alternate processor 1101 can serve as the flight computer, rather than returning control to the primary processor 1100. Furthermore, the primary processor 1100 and the alternate processor 1101 maintain stability of the UAS 100 during switching control between the two processors.

In some embodiments, the alternate processor and safe mode capabilities described with respect to FIGS. 10 and 11 enable the UAS 100 to be useful in a variety of situations. For example, if the UAS 100 is used to deliver a package to a recipient, but there is an obstruction within the delivery area, then the recipient or other person observing the obstruction can act as the safety observer 106 to initiate a safe mode procedure, such as holding altitude or hovering, while the obstruction is cleared. In some embodiments, workers or safety personnel set up an automated system with respect to the obstruction (e.g., adjacent or within the vicinity of the obstruction) while working to clear the obstruction, so that the automated system detects the incoming UAS 100 and transmits a signal to it to initiate the safe mode procedure. Once the obstruction is clear, the recipient, other person, or remote pilot can resume the delivery process. In another example, if the UAS 100 is used to view an area (e.g., survey a farm or ranch, inspect a high-voltage transmission line, etc.), but another aircraft (e.g., a crop duster spraying a field, a helicopter working on the transmission line, etc.) is operating in the same area, then the safety observer 106 (e.g., a person on the ground, the pilot of the other aircraft, etc.) can initiate a safe mode procedure (e.g., holding altitude, hovering, landing, etc.), until the other aircraft passes out of the way, and then release the UAS 100 to continue its normal operations.

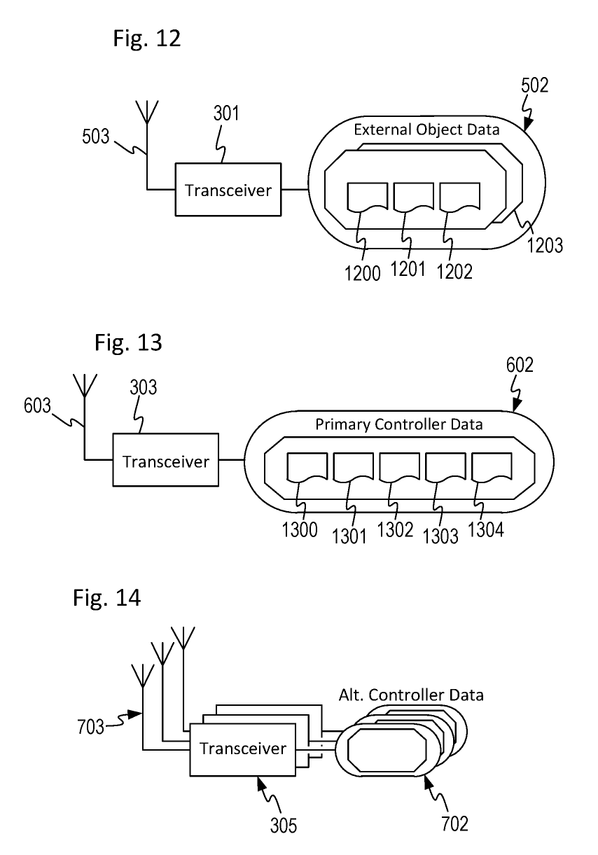

FIGS. 12-15 show the data flow for additional features of the data exchanged between components of the UAS control system 300, in accordance with some embodiments. In some embodiments, data can be passed between the UAS 100 and the external object tracker 101, the primary controller 103, and the alternate controller 104, or any combination thereof. Data that is transmitted and/or received by the transceivers 307a-c generally includes external object data 502, primary controller data 602, alternate controller data 702, etc.

As shown in FIG. 12, in some embodiments, the external object data 502 includes data about the external object tracker 101 and optionally the external object 102, e.g., position data 1200, velocity data 1201, orientation data 1202, etc. In some embodiments, the external object data 502 also includes additional parameters 1203, for example, the location, orientation, and/or velocity, of the UAS 100 in physical space as determined by devices external to the UAS 100. When the additional parameters 1203 are provided, some or all of the data from the sensor subsystem 408 may no longer be needed to maintain stability of the UAS 100.

As shown in FIG. 13, in some embodiments, the primary controller data 602 includes inputs 1300 for control of the UAS 100, a flight mode selector 1301 for the motion control system 406, a flight mode selector 1302 for the control computer 400, an alternate mode selector 1303, payload commands 1304, etc. The inputs 1300 can include roll, pitch, heading, yaw, flap position, engine speed, thrust, throttle, etc. The inputs 1300 can be provided by the primary controller 103, the external object tracker 101, or the alternate controller 104.

In some embodiments, the flight mode selector 1301 for the motion control system 406 includes data specifying what type of flight mode or operations are to be used by the motion control system 406. The flight mode selector 1301 can specify, for example, control of the UAS 100 with respect to the orientation of the primary controller 103.

In some embodiments, the flight mode selector 1302 for the control computer 400 provides additional options, such as: (i) selecting the type of coordinate system schema for the control computer 400 to use, e.g., rectilinear, cylindrical, or spherical coordinates, and (ii) heading lock. In the case where heading lock is enabled, the heading and bearing of the UAS 100 are the same. If heading lock is disabled, the heading and bearing of the UAS 100 are independent. For example, in fixed wing aircraft the heading and bearing are typically tightly coupled. With rotary aircraft, such as helicopters or drones, however, the heading and bearing have the option to be independent, i.e. the UAS 100 can move in a direction other than that in which it is pointing.

In some embodiments, the alternate flight mode selector 1303 includes data identifying priority of the commands from the alternate controller 104. Once priority is established, for example, requests for control can be made, control can be relinquished to the alternate controller 104, or the UAS 100 can be placed into a safe mode by either the primary controller 103 or the alternate controller 104. In safe mode, for example, the UAS 100, as a rotary aircraft, can hover and then descend slowly to land. The landing can be according to predefined instructions specifying, for example, the descent rate, orientation of the UAS 100, blocking out of received data from other controllers in order to maintain safe mode, etc.

In some embodiments, the payload commands 1304 includes any commands for operating other equipment on the UAS 100. For example, the payload commands 1304 can control the camera 107, landing gear, etc. In some embodiments, the payload commands 1304 are generated by a payload operator using a separate controller to independently transmit the payload commands 1304 through another transceiver. For example, a camera operator may have a controller for transmitting camera control commands to operate the camera 107 through an independent camera operating RF link.

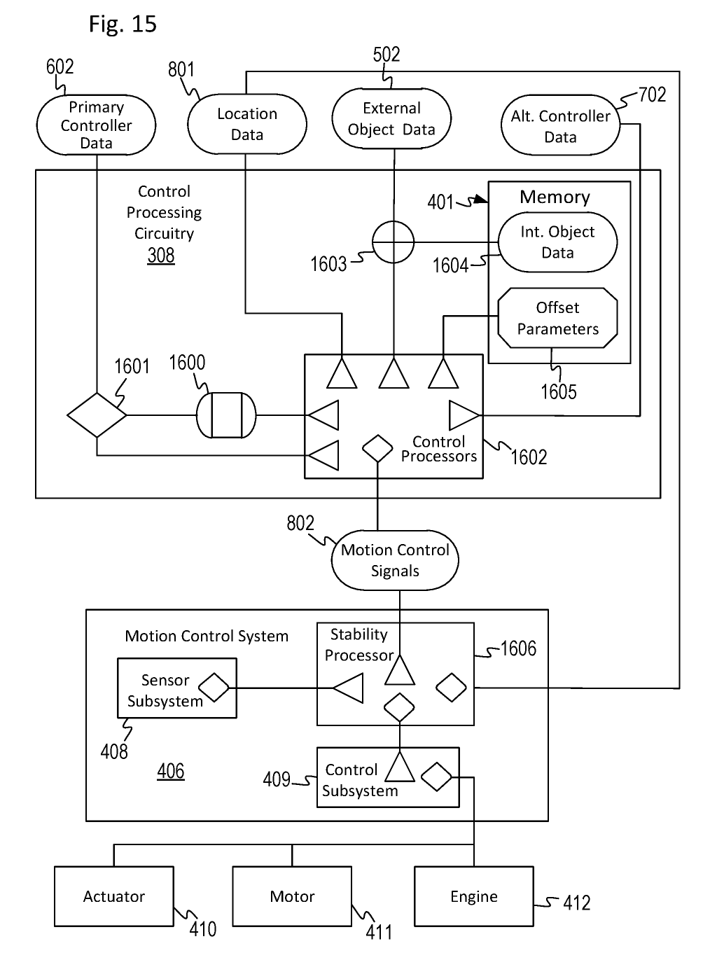

As shown in FIG. 14, in some embodiments, there can be more than one source of the alternate controller data 702 received by the UAS 100. Each one of the sources can contain all or a subset of the data types from the primary controller data 602. For example, there can be multiple alternate controllers 104 each providing alternate controller data 702 to the UAS 100, one establishing the priority of each of the additional alternate controller data 702 for control of roll, pitch, heading, yaw, flap position, engine speed, thrust, throttle, etc. Each alternate controller 104 can have its own alternate transceiver 305 and unique data path from the alternate controller 104 to the control computer 400 on board the UAS 100. In some embodiments, the multiple alternative controllers 104 are used by multiple safety observers 106, who independently can place the UAS 100 into safe mode.

FIG. 15 shows the data flow for additional features of the control processing circuitry 308 and motion control system 406, in accordance with some embodiments. In some embodiments, the control processing circuitry 308 and the motion control system 406 enable the selection of multiple operating modes (e.g., a safe mode, a direct control mode, a course lock mode, a heading lock mode, a point of interest mode, a semi-autonomous follow mode, a waypoint or choreographed mode, a coordinated flight/hybrid flight mode, etc.) when using a combination of the UAS 100 and the primary controller 103.

In some embodiments, the UAS 100 allows basic control functions: change velocity, change orientation (roll, pitch, and heading), and change bearing. For example, there can be three primary axes, each of which are orthogonal to the others, and when defined relative to the UAS 100, these become the longitudinal axis, the transverse axis, and the orientation axis. The heading is the rotation measured around the orientation axis, and is responsible for the orientation of where the “front” of the UAS 100 is pointed. The roll is the rotation measured around the longitudinal axis, and is response for the “banking” of the UAS 100 (most commonly in aerial systems). The pitch is the rotation around the transverse axis and is responsible for the “pitch up/down” of the UAS 100. The bearing is the direction of the velocity vector of the UAS 100. In certain implementations, the heading and bearing are directly coupled, i.e. as the heading of a fixed wing “airplane-like” unmanned system changes, so must the bearing also change. In other platforms, the heading and bearing are largely (if not entirely) decoupled, i.e. the heading of a rotor-wing unmanned system can change independent of the bearing, and vice versa.

In some embodiments, the path of the UAS 100 as if traced along the ground of the Earth (sea-level elevation, local natural or artificial topography, etc.) is referred to as the “track.” Combining the track with the altitude of the UAS 100 along the track provides the point in physical space of the UAS 100 as it moves. Combining the track and altitude with respect to time provides the history of the travel path of the UAS 100. Combining the track and altitude with respect to time along with the bearing provide the velocity vector of the UAS 100 along its travel path.

In some embodiments, the primary controller data 602 (flight control commands) are received by the UAS 100 from the primary controller 103 to change the operation of the UAS 100 in order to execute a maneuver or other change motion or position. A current state of the UAS 100 can be described in terms of, for example, position, velocity, orientation, etc. This state can be correlated, or expressed in terms of, the coordinate system affixed to the UAS 100, the primary controller 103, or alternate affixed point in physical space at the surface of the Earth. State coordinate systems can include, for example, rectilinear, circular, polar, etc.

In some embodiments, a first coordinate system is used relative to the UAS 100 and is stationary with respect to it. Similarly, the external object tracker 101 can have a second coordinate system stationary relative to the external object tracker 101. Additionally, the primary controller 103 can have a third coordinate system stationary relative to the primary controller 103. Also, the received flight control commands can be expressed in rectilinear vectors, cylindrical vectors, spherical vectors, etc. Furthermore, the external object tracker 101 can have a state which can be correlated, or expressed in terms of, a particular coordinate system. Also, at least a portion of the correlating of the external object tracker 101 can occur concurrently with the correlating of the UAS 100.

In some embodiments, the received flight control commands reflect only a change in the state of the UAS 100 relative to its present state. In other words, the received commands can be decoupled from the commands already existing that govern the state of the UAS 100. For example, if the UAS 100 is following the external object tracker 101, then the received commands can be only a change relative to another object or reference frame. For example, a change in distance between the external object tracker 101 can be aligned with the UAS 100. In this example, instead of the UAS 100 staying aligned with the external object tracker 101, the UAS 100 receives a command that the UAS 100 is to move to a position a certain distance in the Y direction in some other coordinate system, for example that of the primary controller 103. This command can be received by the UAS 100 and translated into a command in the coordinate system of the UAS 100. As a result, the UAS 100 can move to a position at the certain distance in the Y direction (or its equivalent) in the coordinate system of the external object tracker 101. Such a change in position is independent of any motion or position of the primary controller 103 and/or the alternate controller 104.

In some embodiments, the UAS 100 utilizes a different coordinate system schema than that of the external object tracker 101 and/or the primary controller 103. Accordingly, the received commands are translated by either the primary controller 103 or the UAS 100 from being expressed in terms of the first coordinate system (stationary with the UAS 100) to being expressed in terms of the second coordinate system (stationary with the external object tracker 101). In particular, in some embodiments, a coordinate transformer 1600 within the control processing circuitry 308 performs the translation. Once translated, the motion control signals (command data) 802 for the UAS 100 can be modified based on the translated received commands. Control parameters can be, for example, roll, pitch, heading, yaw, flap position, engine speed, thrust, throttle, etc. The modification of the control parameters can cause a corresponding change in the operation of the UAS 100 to cause the desired change in state specified by the commands from the primary controller 103. The UAS coordinated control system described herein can also be distributed to form part of the UAS 100, the external object tracker 101, and/or the primary controller 103. Accordingly, any of the receiving, translating, and modifying described above can be executed by the UAS coordinated control system.

In some embodiments, a switch 1601 selects between: (i) processing commands in the coordinate system of the UAS 100 or (ii) processing the primary controller data 602 through the coordinate transformer 1600 before sending the commands/data to one or more control processors 1602 (e.g., similar to 1000, 1001, 1100, 1101, or at least a portion of the control computer 400). Such a coordinate transformation is done if the coordinate system of the external object tracker 101 is not the same as the coordinate system of the UAS 100. For example, a coordinate transformation can be done when the primary controller data 602 is in terms of a spherical coordinate system and the external object data 502 is, and/or the UAS 100 operates, in terms of a rectilinear coordinate system. The coordinate transformer 1600 can then perform the requisite mathematical operations to transform the primary controller data 602 from a spherical coordinate system to a rectilinear coordinate system.

In some embodiments, prior to receiving a switching command at the control processor 1602, the movement (position, velocity, altitude, etc.) of the UAS 100 is controlled by the external object tracker 101. Upon receiving the switching command, the movement of the UAS 100 is responsive to the commands from the primary controller 103 that specify differential changes in the movement of the UAS 100 relative to the external object tracker 101.

In some embodiments, a toggle 1603 allows the use of either the external object data 502 or internal object data 1604 (e.g., stored in the computer memory unit 401). For example, when using the external object data 502 the UAS 100 can be in a tethering, following mode (semi-autonomous follow mode) or coordinated flight/hybrid flight mode. When using the internal object data 1604, only the primary controller data 602, the location data 801, offset parameters 1605 (e.g., stored in the computer memory unit 401), and alternate controller data 702 can be used to control the motion of the UAS 100 in waypoint/choreographed flight modes.

In some embodiments, a stability processor 1606 receives and interprets the motion control signals (command data) 802. The motion control signals 802 are in the coordinate system of the UAS 100. Along with input from the sensor subsystem 408, commands can be issued to the control subsystem 409 in order to provide stabilized motion of the UAS 100. The stabilized motion can be relative to the external object data 502, the primary controller data 602, the alternate controller data 702, or any combination thereof.

In some embodiments, the control processing circuitry 308 computes, based on data received from the external object tracker 101 and the sensor subsystem 408, the appropriate values for the updated offset parameters 1605. The control processing circuitry 308 also generates the motion control signals (command data) 802 to be sent to the motion control system 406 in order to achieve the updated offset parameters 1605. As the external object tracker 101 continues to travel along in a straight track/line along the arrow 111 (FIG. 1), the UAS 100 maintains the updated offsets parameters 1605 resulting in the line or track indicated by arrows 115, 121, 124.

In some embodiments, the control processing circuitry 308, the primary controller 103, the external object tracker 101, and/or the alternate controller 104 use the same coordinate system, e.g., a rectilinear coordinate system, for performing calculations or determining parameters or control commands. In this case, no coordinate transformation is required.

In some embodiments, the choice of coordinate system is selected by the primary controller 103. Thus, an alteration of the state of the UAS 100 could be performed, for example, in the case where the primary controller 103 and/or the external object tracker 101 uses a polar (R, θ) coordinate system centered at the external object tracker 101, but the control processing circuitry 308 uses a rectilinear coordinate system to locate the UAS 100. In this example, a coordinate transformation such as X=R cos (0), Y=R sin (0) could be performed by the coordinate transformer 1600 to transform command(s) from the polar coordinate system of the primary controller 103 to the rectilinear coordinate system used by the control processor 1602.

In some embodiments, such as the example of FIG. 2, to cause the desired change in offsets, the control processing circuitry 308 can (in its X-Y coordinate system) increase the speed of the UAS 100 in the X direction and decrease the acceleration required for the turn in the Y direction. The net result being the UAS 100 achieving the position 207 where the offsets relative to the X-Y coordinate system of the external object tracker 101 are similar to those in the example of FIG. 1.

In the example situations of FIGS. 1 and 2, the tracks or paths of the UAS 100 are intended only as examples. Depending on the specific algorithms implemented in and/or limitations of the hardware of the UAS 100, the particular track may be different, even in similar situations. In some embodiments, an example of such an algorithm is one in which the turning radius of the UAS 100 is restricted, possibly to limit acceleration forces on the components of the UAS 100, or due to the momentum of the UAS 100 and the power of its motor 411 or engine 412. Another example relating to limitations of the hardware can be given with a comparison between the change in tracks of a multi-rotor drone and of a fixed wing aircraft. A drone can almost immediately change its heading with appropriate application of thrust to its various rotors. In contrast, a fixed wing aircraft can only rely on changes due to modifications in flap position and thrust.

In some embodiments, a sequence of changes can be executed in terms of differences between an actual track and a desired track for the UAS 100 using the X, Y and Z offset parameters. In some embodiments, for example, a sequence of changes is performed with waypoint navigation. In some embodiments, the control processing circuitry 308 receives and stores data specifying a desired track transmitted from the external object tracker 101, the primary controller 103, and/or the alternate controller 104. The actual track is computed by the control processing circuitry 308 and stored as the internal object data 1604. Differential measurements are obtained based upon the difference between the actual track and altitude and the desired UAS 100 system movement. Additional manifestation of inputs (from one or more of the alternate controller 104) modify the movement of the UAS 100 with respect to the desired system movement. These inputs are either direct inputs (in the event of a common coordinate system between the control processor 1602 and the external object tracker 101) or processed by the control processor 1602 using coordinate transformation methods. Based upon both the differential measurements (between the actual and desired track and altitude) and the additional manifestation of inputs, the motion control signals (command data) 802 is generated and sent to the motion control system 406 to provide stability to the UAS 100 while changing motion, heading, and orientation. As a result, the UAS 100 follows the desired track or can be further modified, for instance providing additional offset, as a result of commands from the primary controller 103 and/or the alternate controller 104. For example, the UAS 100 can be controlled to follow car as the external object 102 (to which the external object tracker 101 is attached) to obtain a motion picture sequence of the car driving off a cliff. As the car drives off the cliff, the alternate controller 104 or the primary controller 103 can transmit a command to toggle 1603 between the external object data 502 and the internal object data 1604, which contains the continuation of the car's path had it not drove off the cliff. This action will prevent the UAS 100 from following the car down the cliff face.

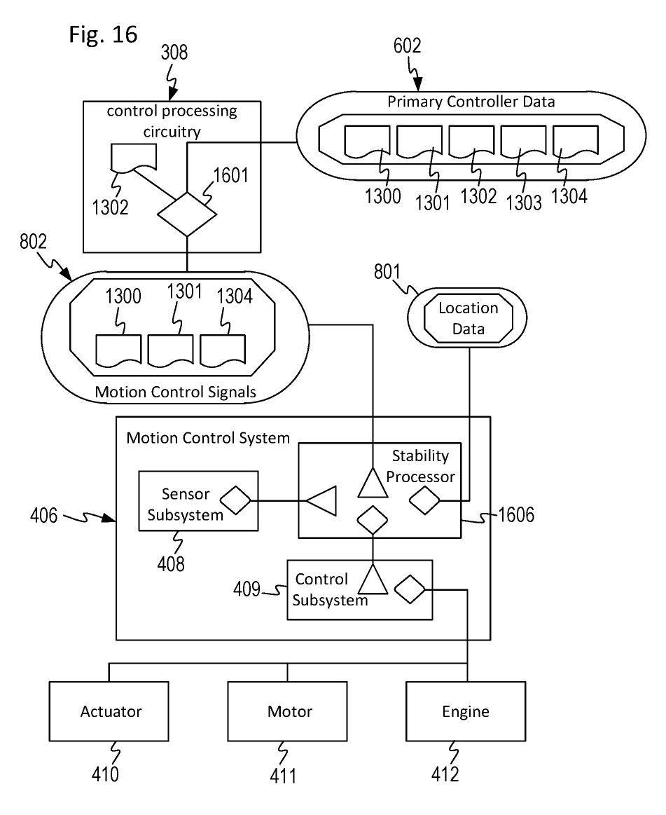

FIG. 16 shows the data flow for additional features of the control processing circuitry 308 and motion control system 406, in accordance with some embodiments in which commands from the UAS 100 are not processed by the control processing circuitry 308. In this example, the control processing circuitry 308 has not received instructions from the flight mode selector 1302 to set the switch 1601 to enable the control processing circuitry 308. In this mode, the control processing circuitry 308 passes the primary controller data 602 through to the motion control system 406. Since the control processing circuitry 308 is not used, a reduced set of data can be passed through to the motion control system 406, e.g., the inputs 1300, the flight mode selector 1301 for the motion control system 406, and the payload commands 1304. To the primary controller 103 or the PIC (either the remote PIC 105, another human in the loop, an autopilot, or another entity in charge of the UAS 100) the control of the UAS 100 proceeds as if the control processing circuitry 308 was not present. Though not shown in FIG. 16, not enabling the control processing circuitry 308, does not limit the ability for alternate controllers 104 to initiate the safe mode.

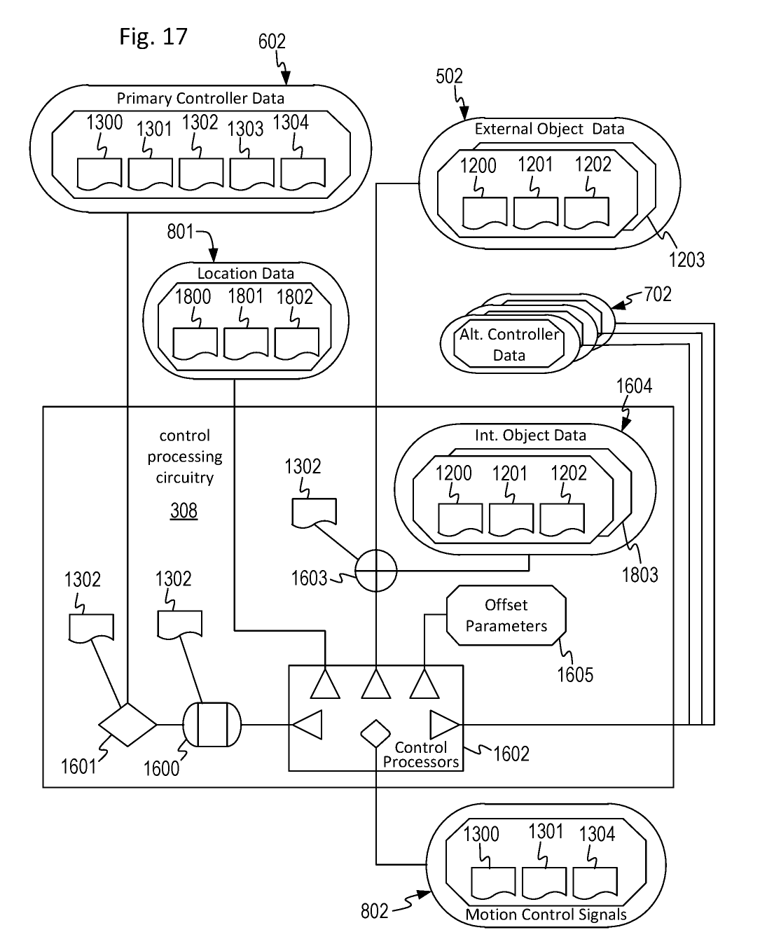

FIG. 17 shows the data flow for additional features of the control processing circuitry 308, in accordance with some embodiments in which commands from the UAS 100 are processed by the control processing circuitry 308. In other words, the control processing circuitry 308 has received instructions from the flight mode selector 1302 to set the switch 1601 to enable the control processing circuitry 308. In this example, the primary controller data 602, the external object data 502, the alternate controller data 702, and the location data 801 are processed through the control processing circuitry 308. In this example, the location data 801 generally includes location parameters 1800, velocity parameters 1801, and orientation parameters 1802. The location parameters 1800 generally describe the location of the UAS 100 in physical space. The velocity parameters 1801 generally include one or more velocity vectors of the UAS 100. The orientation parameters 1802 generally specify the heading, pitch, roll, etc. of the UAS 100. In some embodiments, the internal object data 1604 generally contains other sets of parameters 1803 (e.g., waypoint parameters) similar to the parameters 1800, 1801, and 1802. (The computer memory unit 401 has been removed from FIG. 17 for clarity and ease of description.)

In some embodiments, some of the internal object data 1604 is similar to some of the external object data 502, such as parameters similar to 1200, 1201, and 1202. In some embodiments, waypoint parameters 1803 that contain matched set of parameters 1200, 1201, and 1202, which describe the sequence of commands for the UAS 100. The waypoint parameters 1803 can define a path for the UAS 100, for example, defining a track and/or altitude for the UAS 100 at a number of points in physical space. The waypoint parameters 1803 can be received from, for example, the primary controller 103, the alternate controller 104, and can be stored locally in the computer memory unit 401 of the UAS 100, etc. An operation of sequencing through each of the waypoint parameters 1803 is executed by the control processor 1602. The sequencing can be based upon the system location data 801, through commands from the primary controller 103 and/or the alternate controller 104, or through an internal algorithm. The toggling (by the toggle 1603) between the external object data 502 and the internal object data 1604 can also be initiated during operation by either the primary controller 103 or the alternate controller 104. Data received from the primary controller 103 and/or the alternate controller 104 can control the movement of the UAS 100 relative to the path, in a manner similar to controlling the movement of the UAS 100 relative to the external object tracker 101. For example, the UAS 100 can be following the waypoints and receive additional data from the primary controller 103 and/or the alternate controller 104 to introduce an offset relative to the established waypoints. This offset can be, for example, an altitude from the ground as the UAS 100 follows the track defined by the path, distance from the path, a specified angle relative to the coordinate system of the waypoint(s), etc.

Upon enabling the control processing circuitry 308 by the switch 1601, the offset parameter 1605 can be established. The offset parameter 1605 describes the initial offset in physical space between the location of the UAS 100 and the location of the external object tracker 101. The offset parameter 1605 can also describe the initial offset in the orientation between the UAS 100 and the external object tracker 101. The primary controller 103 can modify the offset parameter 1605 for the UAS 100 to, for example, change the location, orientation, velocity, etc. As described above, the commands received from the primary controller 103 can be processed through the coordinate transformer 1600. This transformation allows the control processor 1602 to execute updated commands modifying the offset parameter 1605 in any coordinate system.

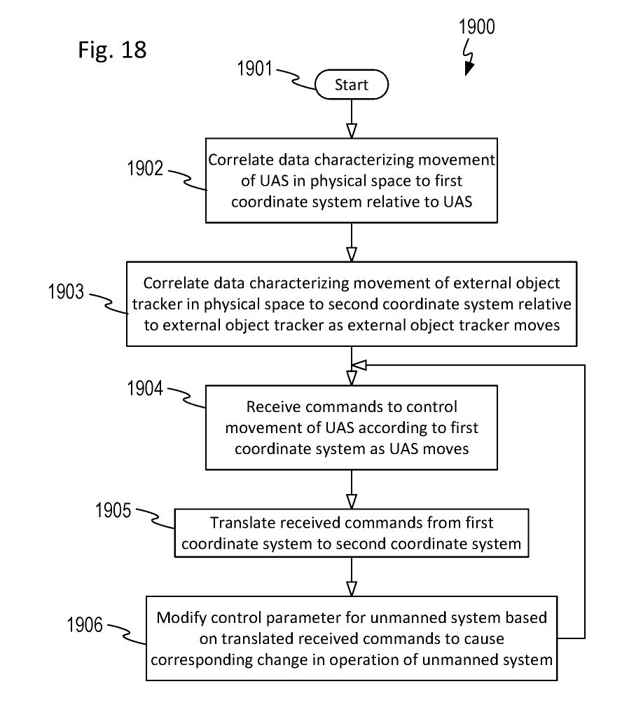

FIG. 18 shows a simplified flowchart for a process 1900 for operation of the UAS 100 (e.g., by execution of the program modules 402, 403, and 405) by modifying control parameters to cause a change in operation of the UAS 100 during the normal flight mode, in accordance with one or more example embodiments. The particular steps and order of the steps are provided for illustrative purposes only. Other processes with different steps, combinations of steps, or order of steps can also be used.

In some embodiments, upon starting (at 1901), the data that characterizes the movement of the UAS 100 in physical space is correlated (at 1902) to a first coordinate system relative to the UAS 100. At 1903, the data that characterizes the movement of the external object tracker 101 in physical space is correlated to a second coordinate system relative to the external object tracker 101 as the external object tracker 101 moves. At 1904, the flight control commands are received by the UAS 100 from the primary controller 103 to control movement of the UAS 100 according to the first coordinate system as the UAS 100 moves. At 1905, the received flight control commands are translated from the first coordinate system to the second coordinate system. At 1906, at least one control parameter (e.g., of the offset parameters 1605) for the UAS 100 is modified based on the translated received flight control commands. The modification causes a corresponding change in operation of the UAS 100 through the motion control signals 802 to the various actuators 410, motors 411, and engines 412. The process 1900 repeats 1904-1906 until terminated or interrupted by initiation of a safe mode. Termination of the safe mode generally returns control to 1904.

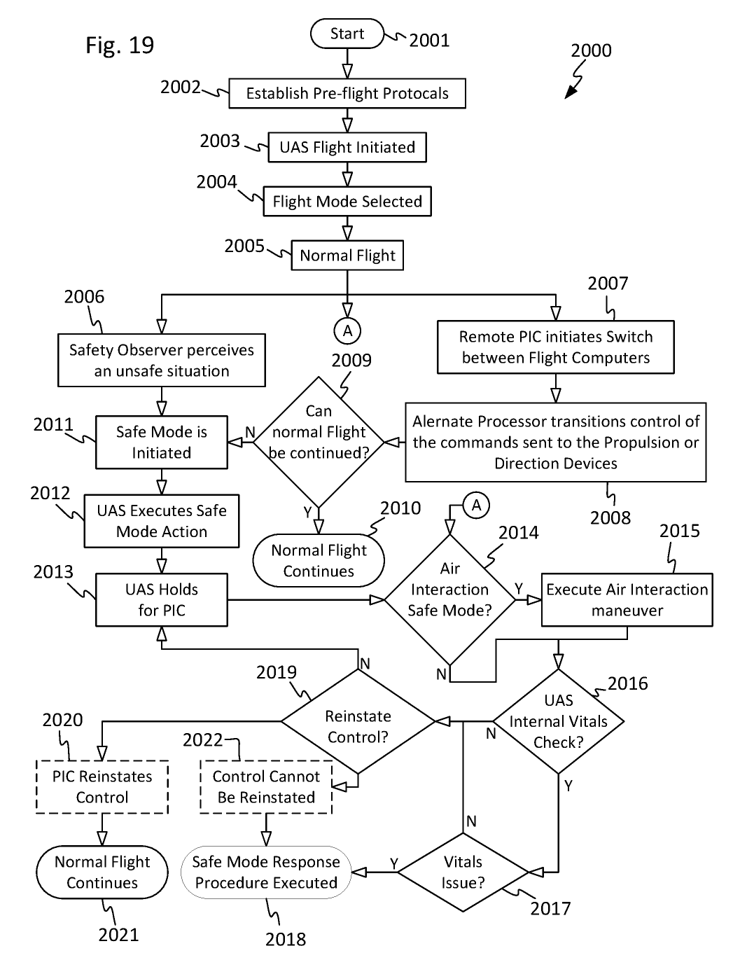

FIG. 19 shows a simplified flowchart for a process 2000 for operation of the UAS 100 (e.g., by execution of the program modules 402, 403, 404, and 405) by modifying control parameters to cause a change in operation of the UAS 100, in accordance with one or more example embodiments. The particular steps and order of the steps are provided for illustrative purposes only. Other processes with different steps, combinations of steps, or order of steps can also be used.

In some embodiments, upon starting (at 2001), pre-flight protocols when the UAS 100 is unable to reinstate previous control procedures or protocols (e.g., the type of basic safe mode response for fixed wing systems, the safe flight corridors for the in-air interactions during safe mode for the pending environment, the flight rules for the in-air interactions during safe mode, the desired emergency procedures to be performed during a hold for the pilot, etc.) are established at 2002. At 2003, flight is initiated, i.e., the UAS 100 is launched. At 2004, the normal flight mode is selected by a command received from the primary controller 103. (Example flight modes include, but are not limited to, a direct control mode, a course lock mode, a heading lock mode, a point of interest mode, a semi-autonomous follow mode, a waypoint or choreographed mode, and a coordinated flight/hybrid flight mode.) At 2005, the selected normal flight mode is initiated and performance thereof continues until interrupted by initiation of a safe mode.

In some embodiments, the safe mode is entered either when the safety observer 106 perceives a potential unsafe situation (at 2006) or when the remote PIC 105 initiates a switch between the flight computers or processors (e.g., 1100 and 1101). The process at 2006-2022 generally describes the actions or types of actions that are performed during the safe mode. However, after the safe mode is entered, it is possible to interrupt the process at 2006-2022 by yet another safe mode. For example, while the UAS 100 is executing a safe mode action or is being manually operated by the safety observer 106 at any point in the process at 2006-2022, another safety observer 106 may determine that the UAS 100 is approaching an unsafe condition and may interrupt or override the existing safe mode flight operation to cause the UAS 100 to perform a different automatic safe mode action or manually-controlled aerobatic maneuver. Therefore, although the flowchart for the process at 2006-2022 does not show a process branch at each step therein, it is understood that a branch to enter a new safe mode can occur at almost any point.

When the remote PIC 105 initiates the switch, the alternate processor 1101 transitions (at 2008) to control the commands or signals (e.g., the motion control signals 802) sent to the propulsion or direction devices 407. At 2009, the alternate processor 1101 determines whether the normal flight mode can continue. If so, then the normal flight mode continues (at 2010) with the alternate processor 1101 in control. In this case, the process 2000 can branch back to 2005.

If the normal flight mode cannot be continued, as determined at 2009, or the safety observer 106 has perceived an unsafe situation (at 2006) and activated one of the flight control devices or alternate mode activators 306, then the safe mode is initiated at 2011. If the safe mode includes an initial action (e.g., changing altitude or direction, as described above), then the UAS 100 executes the initial safe mode action at 2012 and then holds (e.g., waits while hovering) for the remote PIC 105 (through the primary controller 103) to reinstate control at 2013 or for the safety observer 106 (through the alternate controller 104) to continue control. At 2014, if the safe mode involves an in-air interaction maneuver (e.g., a flight rule or safe flight corridor must be followed or the alternate controller 104 transmitted an alternate flight control command), then the prescribed in-air interaction maneuver is executed at 2015. As mentioned above, in some embodiments, after 2006 or 2007, another safety observer 106 may also initiate another safe mode. Appropriate portions of steps 2006 through 2015 are thus repeated, with control of the UAS 100 being under the alternate controller 104 of the most recent or highest-priority safety observer 106 that initiated a safe mode. For example, during 2013, while the UAS 100 is holding for the remote PIC 105, any safety observer 106 (via one of the alternate controllers 104) can cause the UAS 100 to execute another initial safe mode action at 2012 or additional in-air interaction maneuvers, as in 2014 and 2015.

When the in-air interaction maneuver is completed, or if it was not required at 2014, then the alternate processor 1101 determines (at 2016) whether to perform an internal vitals check of the UAS 100. If so, then the alternate processor 1101 initiates a vitals check procedure. For example, the alternate processor 1101 checks whether the UAS 100 is low on battery power or fuel, whether there is a failure or fault in the flight system, whether there is a failure or fault in the payload, etc. If there is an issue, problem or fault with any of the vitals, as determined at 2017, then the UAS 100 transmits a message describing the result of the vitals check to the alternate controller 104 and attempts to execute (e.g., at 2018) a controlled safe mode response procedure, such as landing or returning to base, and then the process 2000 terminates.

If there was no issue with the results of the vitals check (as determined at 2017), or the vitals check was not performed (as determined at 2016), then the alternate processor 1101 determines (at 2019) whether the remote PIC 105 has attempted to reinstate control of the UAS 100 (or control cannot be reinstated). If not, then the alternate processor 1101 returns to 2013 to hold for the remote PIC 105/primary controller 103 to reinstate control at 2013 (or for the safety observer 106/alternate controller 104 to continue control). The process 2000 continues to loop through 2013-2019 until the remote PIC 105/primary controller 103 reinstates control, as determined at 2019, (or the safety observer 106/alternate controller 104 continues control). If the remote PIC 105 reinstates control (2020) of the UAS 100, as determined at 2019, then the normal flight mode continues (at 2021), and the process 2000 can return to 2005. On the other hand, if control cannot be reinstated (2022), as determined at 2019, then the UAS 100 attempts to execute (at 2018) a controlled safe mode response procedure, such as landing or returning to base, and then the process 2000 terminates. The process 2000 continues until it is terminated or the UAS 100 is turned off.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or an assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor, for displaying information to the user and a keyboard and a pointing device, such as for example a mouse, a touchpad or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one” or “one or more” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. An unmanned aerial vehicle control system comprising:
an unmanned aerial vehicle having a control processing circuitry and a motion response subsystem in operative communication, wherein: (i) the unmanned aerial vehicle is configured to remotely accept a flight control command and a collision avoidance command; (ii) the control processing circuitry is configured to receive the flight control command and to produce a motion control signal that implements the flight control command in an absence of the collision avoidance command; (iii) the motion response subsystem is configured to cause the unmanned aerial vehicle to travel along a path in response to the motion control signal in accordance with the flight control command; and (iv) the control processing circuitry is configured to receive the collision avoidance command and to stop the unmanned aerial vehicle from traveling along the path in response to the collision avoidance command;
a primary controller having a flight control device, wherein the primary controller is configured to remotely provide the flight control command to the unmanned aerial vehicle in response to manipulation of the flight control device by a remote pilot; and
an alternate controller, separate from the primary controller, having an alternate mode activator, wherein the alternate controller is configured to remotely provide the collision avoidance command to the unmanned aerial vehicle in response to activation of the alternate mode activator by a remote observer.

2. The unmanned aerial vehicle control system of claim 1, wherein:
the control processing circuitry is configured to bring lateral momentum of the unmanned aerial vehicle to a stop in response to the collision avoidance command.

3. The unmanned aerial vehicle control system of claim 1, wherein:
the control processing circuitry is configured to cause the unmanned aerial vehicle to hover in place in response to the collision avoidance command.

4. The unmanned aerial vehicle control system of claim 3, wherein:
the control processing circuitry is configured to cause the unmanned aerial vehicle to change altitude prior to hovering in place in response to the collision avoidance command.

5. The unmanned aerial vehicle control system of claim 3, wherein:
the alternate controller further has second and third alternate mode activators;
the alternate controller is configured to remotely provide a second collision avoidance command to the unmanned aerial vehicle in response to activation of the second alternate mode activator by the remote observer;
the alternate controller is configured to remotely provide a third collision avoidance command to the unmanned aerial vehicle in response to activation of the third alternate mode activator by the remote observer;
the control processing circuitry is configured to cause the unmanned aerial vehicle to gain altitude prior to hovering in place in response to the second collision avoidance command; and
the control processing circuitry is configured to cause the unmanned aerial vehicle to lose altitude prior to hovering in place in response to the third collision avoidance command.

6. The unmanned aerial vehicle control system of claim 1, wherein:
the control processing circuitry is configured to cause the unmanned aerial vehicle to change a direction of travel of the unmanned aerial vehicle in response to the collision avoidance command.

7. The unmanned aerial vehicle control system of claim 6, wherein:
the collision avoidance command includes a second flight control command that indicates the change in the direction of travel of the unmanned aerial vehicle.

8. The unmanned aerial vehicle control system of claim 7, wherein:
the control processing circuitry is configured to receive the second flight control command and to produce a second motion control signal that implements the second flight control command; and
the motion response subsystem is configured to cause the unmanned aerial vehicle to travel along a second path in response to the second motion control signal in accordance with the second flight control command.

9. The unmanned aerial vehicle control system of claim 7, wherein:
the alternate mode activator includes a second flight control device and activation of the alternate mode activator includes manipulation of the second flight control device, wherein the alternate controller is configured to remotely provide the second flight control command to the unmanned aerial vehicle in response to manipulation of the second flight control device by the remote observer.

10. The unmanned aerial vehicle control system of claim 6, wherein:
the collision avoidance command includes a velocity vector of another aerial vehicle; and
the control processing circuitry is configured to change the direction of travel of the unmanned aerial vehicle based on the velocity vector of the other aerial vehicle.

11. The unmanned aerial vehicle control system of claim 1, further comprising:
an external object tracker having tracking sensors, wherein the external object tracker is configured to remotely provide, to the unmanned aerial vehicle, external object data indicative of movement detected by the tracking sensors;
wherein:
the unmanned aerial vehicle is configured to accept the external object data; and
the control processing circuitry is configured to receive the external object data and to produce the motion control signal based on the external object data in addition to the flight control command.

12. The unmanned aerial vehicle control system of claim 11, wherein:
the control processing circuitry and the motion response subsystem are configured to maintain the unmanned aerial vehicle at an offset from the external object tracker relative to a location and an orientation of the external object tracker as the external object tracker travels along a second path; and
the offset from the external object tracker is determined based on the flight control command.

13. The unmanned aerial vehicle control system of claim 11, wherein:
the path along which the unmanned aerial vehicle travels is offset from a path along which the external object tracker travels by an offset; and
the offset is determined based on the flight control command.

14. The unmanned aerial vehicle control system of claim 1, wherein:
the control processing circuitry includes a primary processor and an alternate processor;
the primary processor is configured to receive the flight control command and to produce the motion control signal when the primary processor is functioning properly;
the alternate processor is configured to receive the collision avoidance command and to stop the unmanned aerial vehicle from traveling along the path in response to the collision avoidance command; and
the alternate processor is configured to receive the flight control command and to produce the motion control signal when the primary processor is not functioning properly.

15. A method comprising:
transmitting, by a primary controller to an unmanned aerial vehicle in response to manipulation of a flight control device by a remote pilot, a flight control command that indicates a flight path for the unmanned aerial vehicle;
receiving, by the unmanned aerial vehicle, the flight control command;
operating, by the unmanned aerial vehicle, a propulsion device to cause the unmanned aerial vehicle to travel along the flight path in response to the flight control command in an absence of a collision avoidance command;
transmitting, by an alternate controller to the unmanned aerial vehicle in response to activation of an alternate mode activator by a remote observer, the collision avoidance command;
receiving, by the unmanned aerial vehicle, the collision avoidance command; and
operating, by the unmanned aerial vehicle, the propulsion device to cause the unmanned aerial vehicle to stop travelling along the flight path in response to the collision avoidance command.

16. The method of claim 15, wherein:
the operating of the propulsion device brings lateral momentum of the unmanned aerial vehicle to a stop in response to the collision avoidance command.

17. The method of claim 15, wherein:
the operating of the propulsion device causes the unmanned aerial vehicle to hover in place in response to the collision avoidance command.

18. The method of claim 17, wherein:
the operating of the propulsion device causes the unmanned aerial vehicle to change altitude prior to hovering in place in response to the collision avoidance command.

19. The method of claim 17, wherein:
the operating of the propulsion device causes the unmanned aerial vehicle to hover in place in response to the collision avoidance command being of a first type;
the operating of the propulsion device causes the unmanned aerial vehicle to gain altitude prior to hovering in place in response to the collision avoidance command being of a second type; and
the operating of the propulsion device causes the unmanned aerial vehicle to lose altitude prior to hovering in place in response to the collision avoidance command being of a third type.

20. The method of claim 15, wherein:
the operating of the propulsion device causes the unmanned aerial vehicle to change a direction of travel of the unmanned aerial vehicle in response to the collision avoidance command.

21. The method of claim 20, wherein:
the collision avoidance command includes a second flight control command that indicates the change in the direction of travel of the unmanned aerial vehicle.

22. The method of claim 21, wherein:
the operating of the propulsion device causes the unmanned aerial vehicle to travel along a second path in accordance with the second flight control command.

23. The method of claim 21, wherein:
activation of the alternate mode activator includes manipulation of a second flight control device, which generates the second flight control command.

24. The method of claim 20, wherein:
the collision avoidance command includes a velocity vector of another aerial vehicle; and
the operating of the propulsion device causes the unmanned aerial vehicle to change the direction of travel of the unmanned aerial vehicle based on the velocity vector of the other aerial vehicle.

25. The method of claim 15, further comprising:
generating, by an external object tracker having tracking sensors, external object data indicative of movement detected by the tracking sensors;
transmitting, by the external object tracker to the unmanned aerial vehicle, the external object data;
receiving, by the unmanned aerial vehicle, the external object data; and
operating, by the unmanned aerial vehicle, the propulsion device to cause the unmanned aerial vehicle to travel along the flight path based on the external object data in addition to the flight control command.

26. The method of claim 25, further comprising:
operating, by the unmanned aerial vehicle, the propulsion device to maintain the unmanned aerial vehicle at an offset from the external object tracker relative to a location and an orientation of the external object tracker as the external object tracker travels along a second path, wherein the offset from the external object tracker is determined based on the flight control command.

27. The method of claim 25, wherein:
the flight path along which the unmanned aerial vehicle travels is offset from a path along which the external object tracker travels; and
the offset is determined based on the flight control command.

28. The method of claim 15, wherein:
the unmanned aerial vehicle includes a control processing circuitry having a primary processor and an alternate processor;
the receiving of the flight control command comprises receiving, by the primary processor, the flight control command when the primary processor is functioning properly;
the receiving of the collision avoidance command comprises receiving, by the alternate processor, the collision avoidance command; and
the receiving of the flight control command comprises receiving, by the alternate processor, the flight control command when the primary processor is not functioning properly.
